(19) United States
(12) Patent Application Publication
(10) Pub. No.: US 2015/0180246 A1
(43) Pub. Date: Jun. 25, 2015

(54) DAISY-CHAINED NON-CONTACT THERMOMETER CHARGER

(71) Applicant: Jason Roth, Boca Raton, FL (US)

(72) Inventor: Jason Roth, Boca Raton, FL (US)

(73) Assignee: BROOKLANDS, INC., Boca Raton, FL (US)

(21) Appl. No.: 14/134,554

(22) Filed: Dec. 19, 2013

(51) Int. Cl. H02J 7/00

(52) U.S. Cl. CPC H02J 7/0027

(57) ABSTRACT

Systems, methods and apparatus are provided through which in some implementations a daisy-chainable base charger for a non-contact thermometer includes a daisy-chain female port, a daisy-chain male port, at least two conductors that are operably coupled to the daisy-chain female port to the daisy-chain male port that is in the daisy-chainable base charger, and wherein the daisy-chain female port and the daisy-chain male port have complementary physical interfaces, wherein the daisy-chain female port and the daisy-chain male port are on opposite sides of the daisy-chain base charger.

### FIELD

This disclosure relates generally to digital thermometers, and more particularly to the power supply of non-contact thermometer chargers.

### BACKGROUND

Conventional charger bases for non-contact thermometers include a power supply.

### BRIEF DESCRIPTION

In one aspect, a daisy-chainable base charger for a non-contact thermometer includes a daisy-chain female port, a daisy-chain male port, at least two conductors that are operably coupled to the daisy-chain female port to the daisy-chain male port that is in the daisy-chainable base charger, and wherein the daisy-chain female port and the daisy-chain male port have complementary physical interfaces, wherein the daisy-chain female port and the daisy-chain male port are on opposite sides of the daisy-chain base charger.

In some aspects when the daisy-chain female port is mated with a daisy-chain male port that is not in the daisy-chainable base charger, then electric power is operable to flow through the daisy-chain male port that is not in the daisy-chainable base charger and to the daisy-chain female port, and the electric power is operable to flow from the daisy-chain female port to the daisy-chain male port that is in the daisy-chainable base charger, thus providing electric power to the daisy-chain base charger to recharge a battery in the non-contact thermometer.

Apparatus, systems, and methods of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is an isometric front side-view diagram of a plurality of non-contact thermometers in daisy-chained base chargers, according to an implementation.

FIG. 2 is an isometric front side-view diagram of a non-contact thermometer in a daisy-chain base charger, according to an implementation; and

FIG. 3 is an isometric top-side view diagram of a non-contact thermometer and daisy-chained multiple chargers, according to an implementation;

FIG. 4 is an isometric bottom-side view diagram of a non-contact thermometer and daisy-chained multiple chargers, according to an implementation;

FIG. 5 is an exploded-view diagram of a low voltage conductor bar of a non-contact thermometer, according to an implementation;

FIG. 6 is an exploded-view diagram of a charger base and wall mount of a daisy-chain non-contact thermometer charger, according to an implementation;

FIG. 7 is an isometric top-side view diagram of a charger top case of a non-contact thermometer, according to an implementation;

FIG. 8 is an isometric front-side view diagram of pairs of non-contact thermometers in daisy-chained multiple chargers, according to an implementation;

FIG. 9 is an isometric back-side view diagram of pairs of daisy-chained non-contact thermometer chargers, according to an implementation;

FIG. 10 is a block diagram of apparatus to measure temperature from multiple source points, according to an implementation;

FIG. 11 is a block diagram of apparatus to measure temperature from a carotid source point, according to an implementation;

FIG. 12 is an isometric top-view block diagram of an apparatus to measure temperature using both a non-contact thermometer with a right-angled waveguide and not including a contact thermometer, according to an implementation;

FIG. 13 is a side-view block diagram of an apparatus to measure temperature using a non-contact thermometer with a right-angled waveguide, according to an implementation;

FIG. 14 is an isometric block diagram of an apparatus to measure temperature using both non-contact thermometer with a right-angled waveguide and contact thermometer, according to an implementation;

FIG. 15 is a block diagram of apparatus to measure temperature, according to an implementation having a right-angled waveguide;

FIG. 16 is a block diagram of apparatus to measure temperature, according to an implementation in which each of a non-contact thermometer and a contact thermometer are controlled by a separate printed circuit board and the non-contact thermometer has a right-angled waveguide, according to an implementation;

FIG. 17-23 are block diagrams of a sensor collector to guide electromagnetic energy to measure temperature, according to an implementation;

FIG. 24-29 are block diagrams of a shroud of a sensor collector to guide electromagnetic energy to measure temperature, according to an implementation;

FIG. 30 is a representation of display that is presented on the display device of apparatus in FIG. 10-15, according to an implementation that manages both a non-contact sensor and a contact sensor;

FIG. 31 is a representation of display that is presented on the display device of apparatus in FIG. 10-15, according to an implementation;

FIG. 32 is a representation of text displays that are presented on the display device of apparatus in FIG. 10-15, according to an implementation;

FIG. 33-38 are representations of graphical displays that are presented on the display device of apparatus in FIG. 10-15, according to implementations;

FIG. 39 is a flowchart of a method to measure temperature from multiple source points;

FIG. 40 is a flowchart of a method to measure temperature of a forehead and a carotid artery, according to an implementation;

FIG. 41 is a flowchart of a method of determining correlated temperature of a carotid artery, according to an implementation;

FIG. 42 is a flowchart of a method of forehead and carotid artery sensing, according to an implementation;

FIG. 43 is a flowchart of a method to display temperature color indicators, according to an implementation;

FIG. 44 is a flowchart of a method to display temperature color indicators, according to an implementation of three colors;

FIG. 45 is a block diagram of a thermometer control computer, according to an implementation; and

FIG. 46 is a block diagram of a data acquisition circuit of a thermometer control computer, according to an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, apparatus of implementations are described. In the second section, implementations of methods are described. In the third section, a hardware and the operating environment in conjunction with which implementations may be practiced are described. Finally, in the fourth section, a conclusion of the detailed description is provided.

### Apparatus Implementations

In this section, particular apparatus of implementations are described by reference to a series of diagrams.

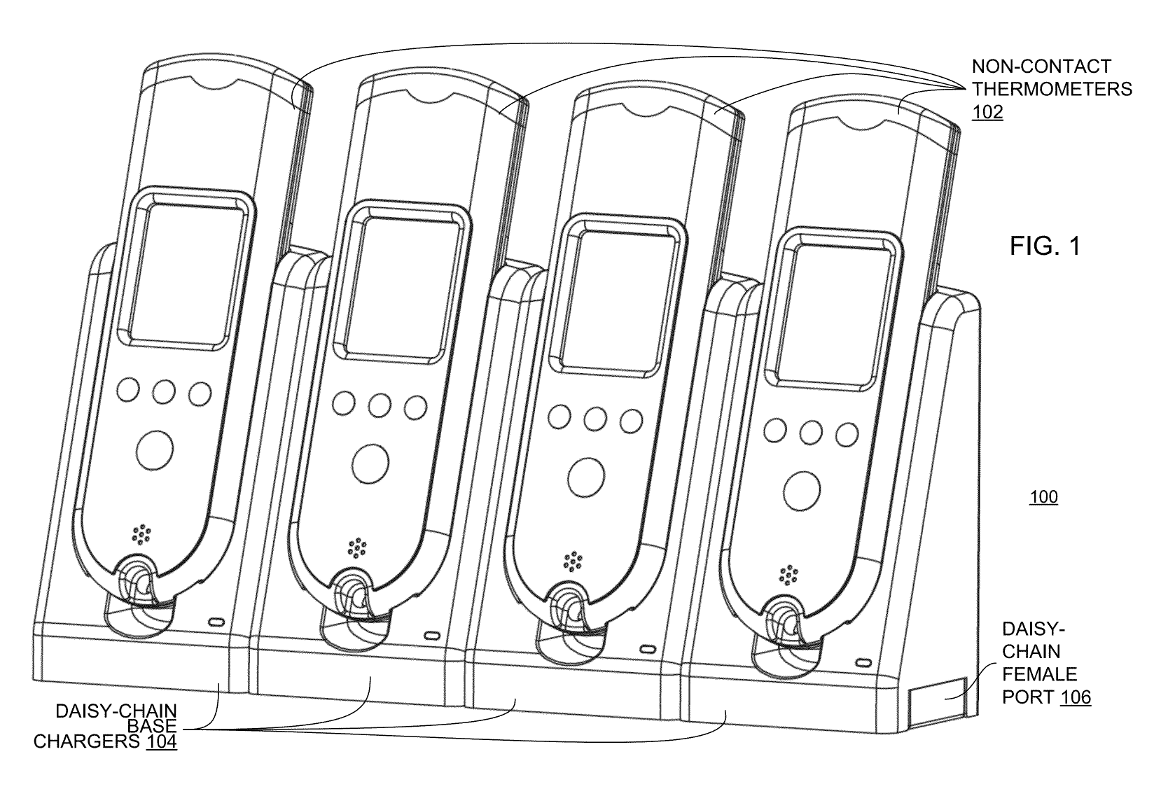

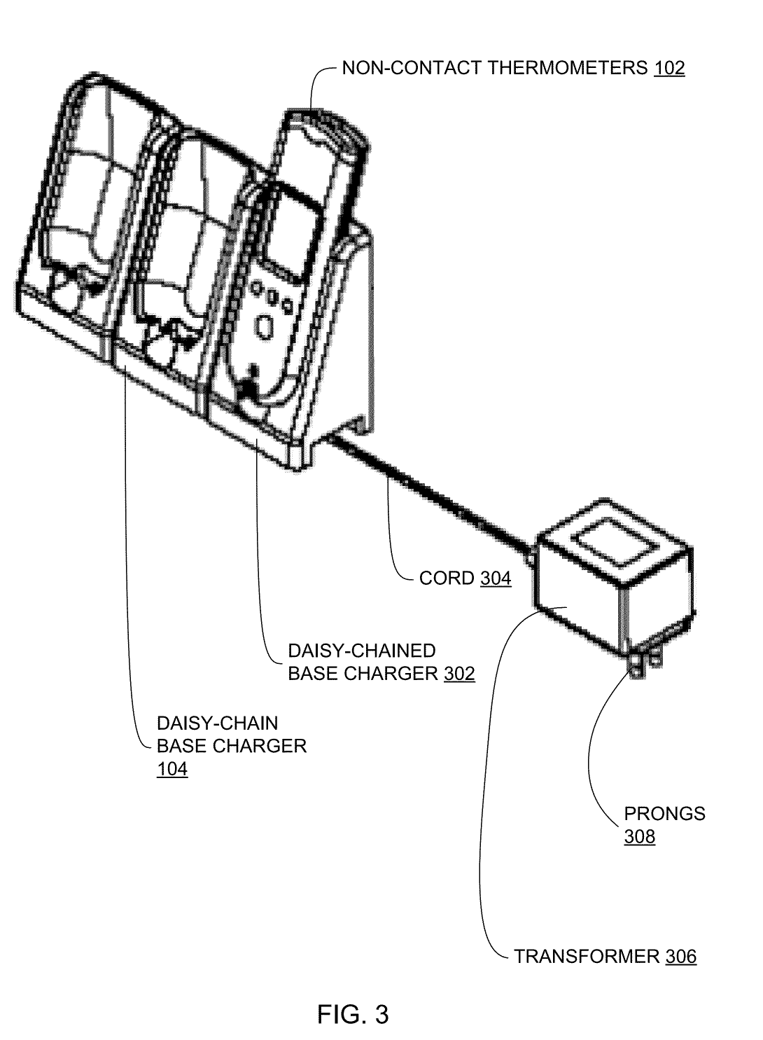

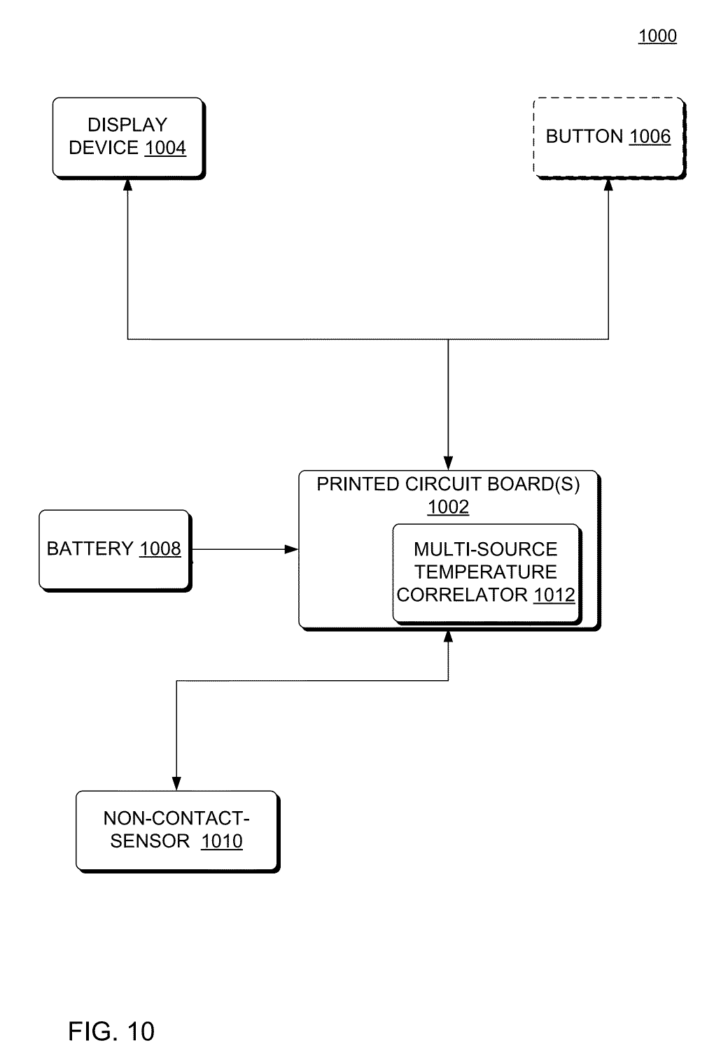

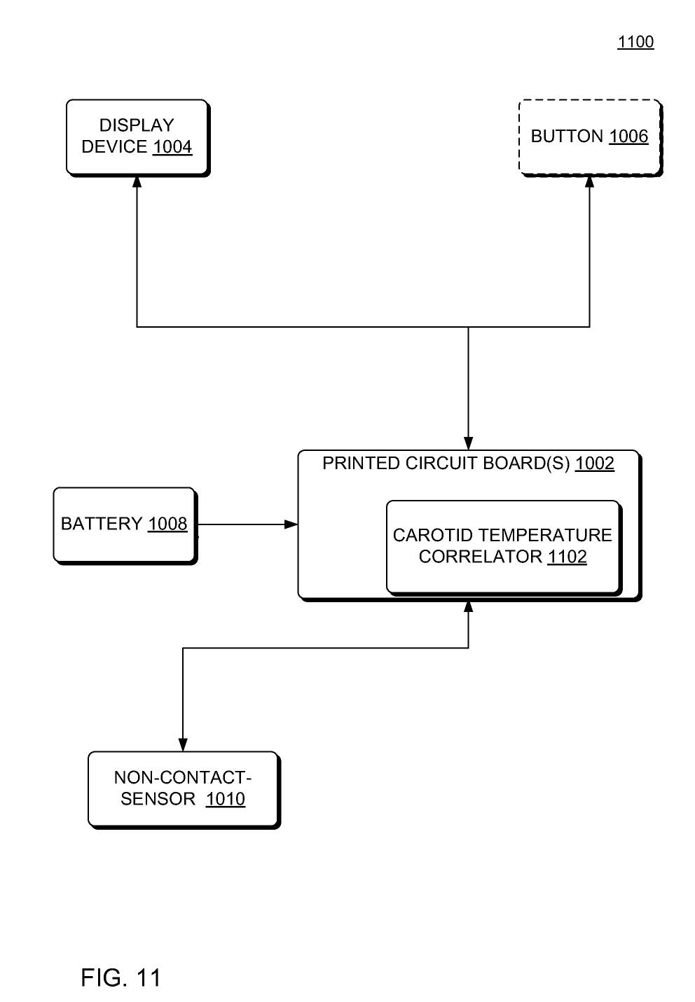

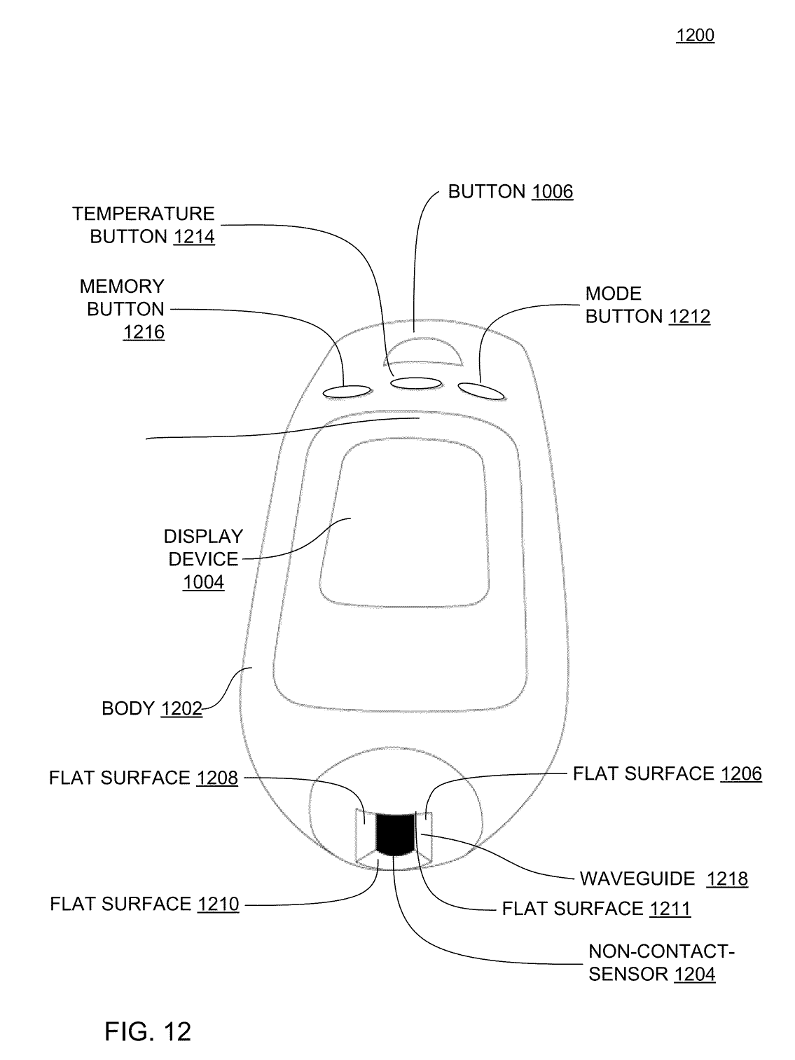

FIG. 1 is an isometric front side-view diagram of pairs 100 of a plurality of non-contact thermometers 102 placed in daisy-chained base chargers 104, according to an implementation. Implementations of the non-contact thermometers 102 are described in greater detail in apparatus 1000 in FIG. 10, apparatus 1100 in FIG. 11 and apparatus 1200 in FIG. 12. Implementation of the daisy-chain base chargers 104 are described in greater detail in FIG. 3-7.

Each of the non-contact thermometers 102 are mated with a daisy-chain base charger 104. Each of the daisy-chain base chargers 104 includes a daisy-chain female port 106 and a daisy-chain male port (not shown). The daisy-chain female port 106 and the daisy-chain male port have complementary physical interfaces. The daisy-chain female port 106 and the daisy-chain male port are on opposite sides of the daisy-chain base charger 104. When a daisy-chain female port 106 is mated with a daisy-chain male port, electric power flows through the daisy-chain male port and the daisy-chain female port 106, and in particular, power flows from the daisy-chain male port to the daisy-chain female port 106, thus providing electric power to each of the daisy-chain base chargers 104 to recharge a battery in each of the non-contact thermometers 102. The daisy-chain base chargers 104 do not include a power cord that is interconnectable to an extant power outlet which reduces the space requirement of each daisy-chain base charger 104 and the cost of each daisy-chain base chargers 104, yet each daisy-chain base charger 104 receives power through the daisy-chain female port 106 and thus each daisy-chain base charger 104 is fully operational with a lower manufacturing cost and smaller size than a daisy-chain base charger 104 that includes a power cord. The smaller size of the daisy-chain base charger 104 that does not include a power cord is particularly for health facilities that require increasing varieties of durable medical equipment in order to serve increasingly various medical conditions that is provided by new medical diagnosis and treatment technology.

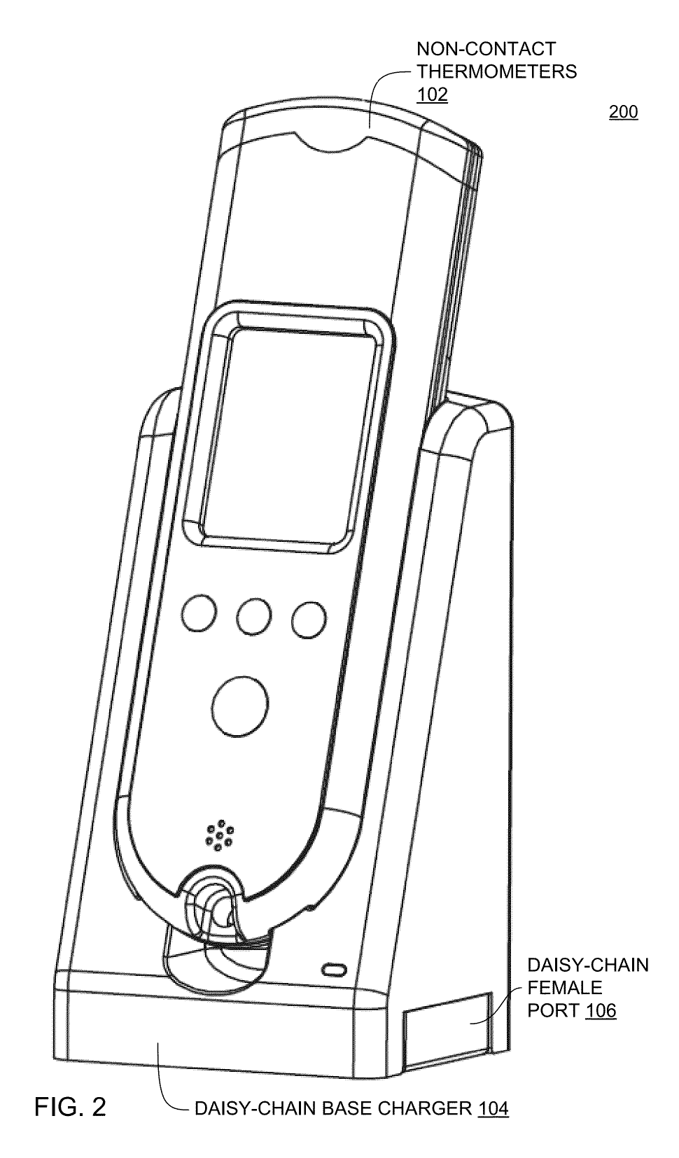

FIG. 2 is an isometric front side-view diagram of a pair 200 of a non-contact thermometer 102 in a daisy-chain base charger 104, according to an implementation.

FIG. 3 is an isometric front side-view diagram of pairs 300 of a plurality of non-contact thermometers 102 placed in daisy-chained base chargers according to an implementation. A daisy-chained base charger 302 is electrically coupled to a cord 304 which is electrically coupled to a transformer 306, the transformer including prongs 308 that are suitable for engaging a conventional electric wall outlet; so that the daisy-chained base charger 302 and the pairs 300 of the plurality of non-contact thermometers 102 placed in the daisy chained base chargers 104 will receive electric power. The daisy-chained base charger 302 is also operably coupled to a daisy-chained base charger 104.

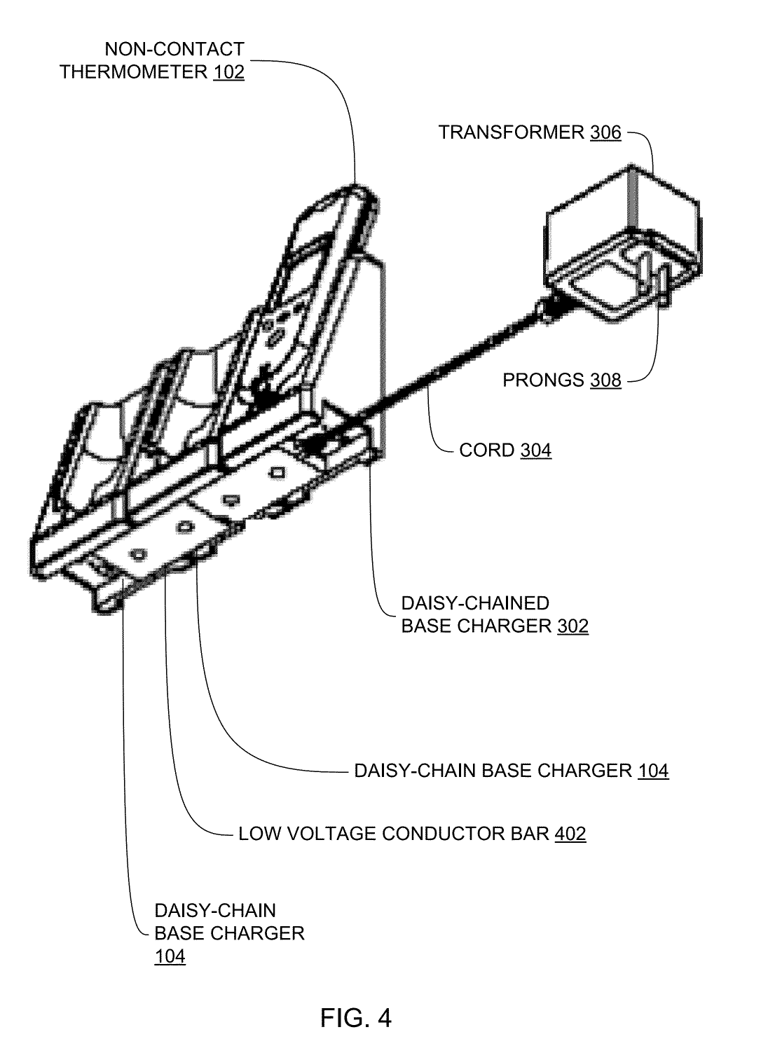

FIG. 4 is an isometric bottom side-view diagram of pairs 300 of a plurality of non-contact thermometers 102 placed in daisy-chained base chargers, according to an implementation that includes a low voltage conductor bar. The daisy-chained base chargers are interconnected by a low voltage conductor bar 402 on the bottom of the daisy-chained base chargers 104 and 302. Power received by the daisy-chained base charger 302 through the cord 304 and the transformer 306 is transmitted from the daisy-chained base charger 302 to daisy-chained base charger(s) 104 through the low voltage conductor bar 402. Each low voltage conductor bar 402 spans and interconnects the base chargers.

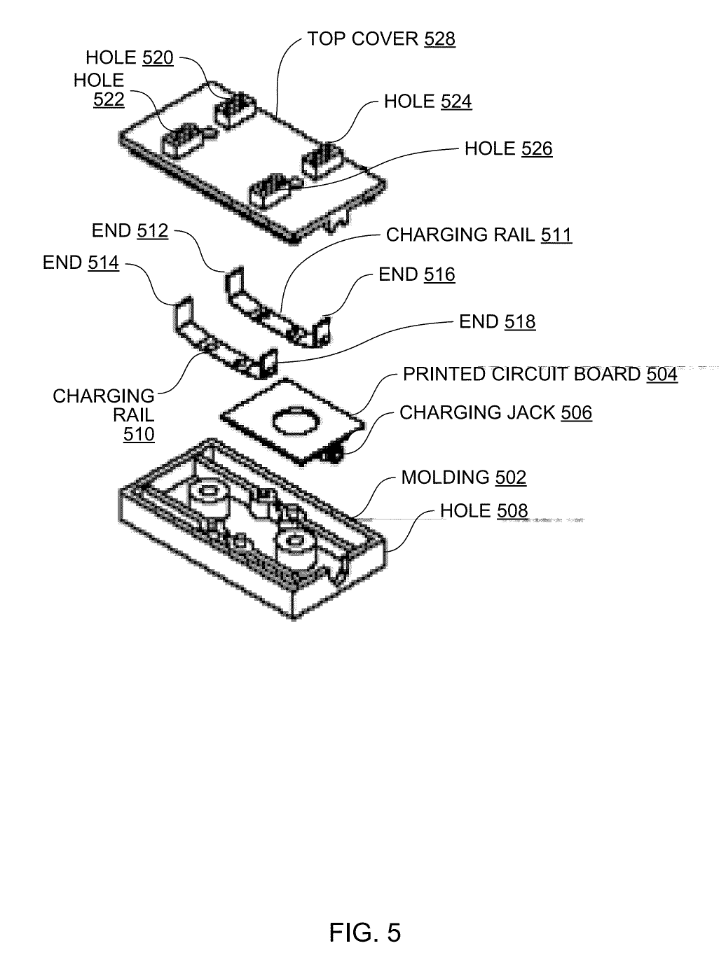

FIG. 5 is an exploded-view diagram of a low voltage conductor bar 500 of a non-contact thermometer, according to an implementation. The low voltage conductor bar 500 includes a molding or housing 502. A printed circuit board (PCB) 504 and a charging jack 506 are electrically and mechanically coupled to each other and mechanically placed within the housing 502 of the low voltage conductor bar 500. The charging jack 506 is extant to a hole 508 in the exterior of the housing 502. One or more low voltage conductor rails 510 and 511 are electrically and mechanically coupled to the charging jack 506. Ends 512, 514, 516 and 518 of the low voltage conductor rails are extant through holes 520, 522, 524 and 526 of a top cover 528 of the low voltage conductor bar 500. The cover 528 is mechanically attached to the housing 502.

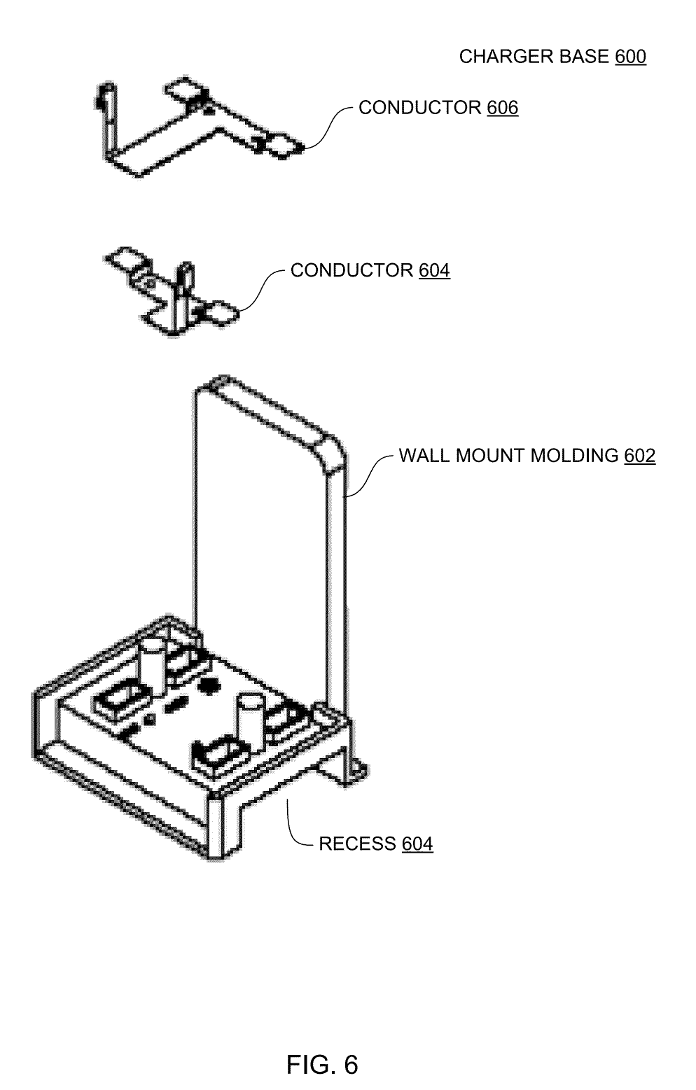

FIG. 6 is an exploded-view diagram of a charger base 600 of a daisy-chain non-contact thermometer charger 700, according to an implementation. The charger base includes a wall mount molding 602. A low voltage conductor bar 500 can be operably coupled to the charger base in a recess 602 of the base charger 600. The base charger 600 also includes a conductor 604 and a conductor 606.

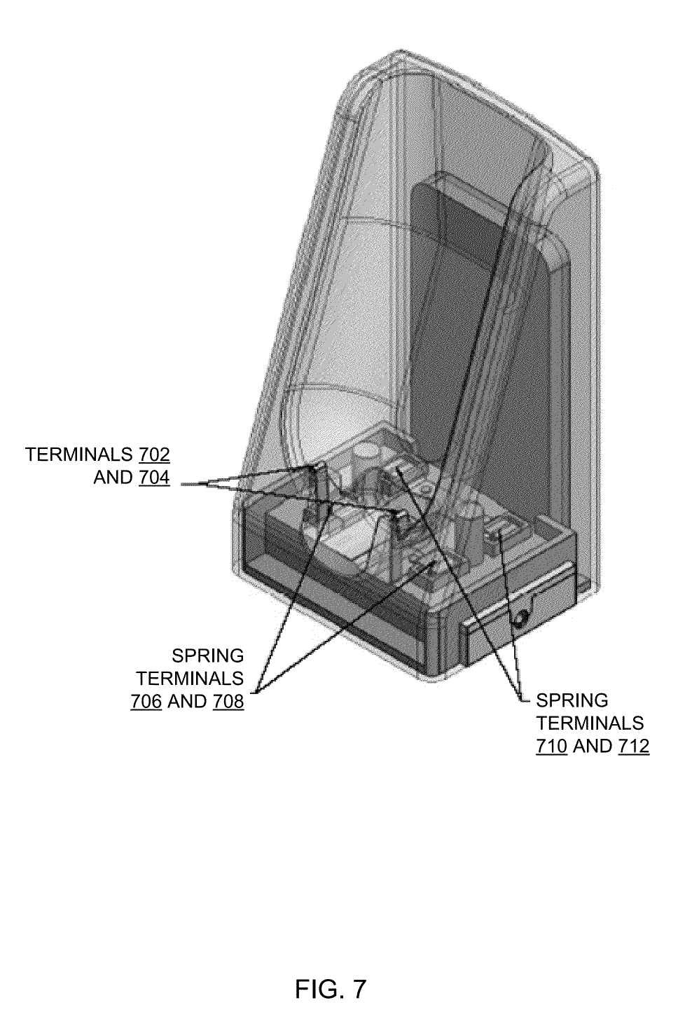

FIG. 7 is an isometric top-side view diagram of a base charger of a non-contact thermometer, according to an implementation. Terminals 702 and 704 provide electrical power when multiple recharger bases 700 are connected. Spring terminals 706 and 708 provide positive electrical power to the charge base 700. Spring terminals 710 and 712 provide positive electrical power to the charge base 700.

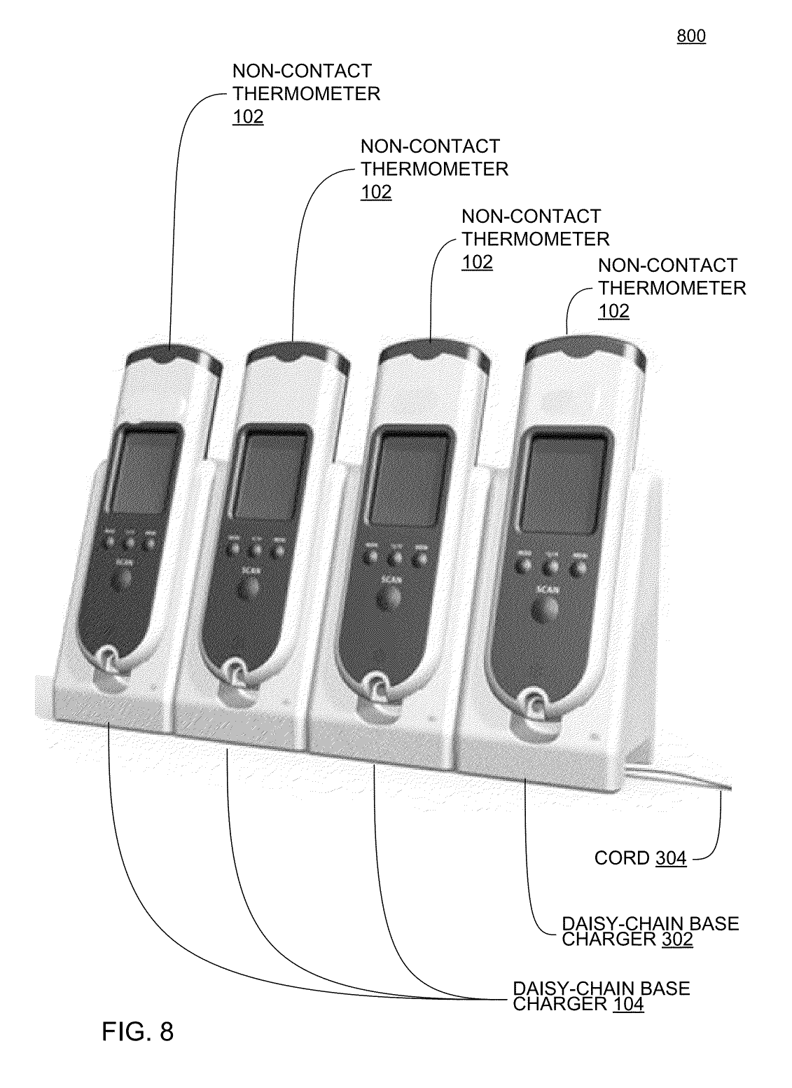

FIG. 8 is an isometric front side-view diagram of three pairs 100 of non-contact thermometers 102 placed in daisy-chained base chargers 104 and one pair of non-contact thermometers 102 placed in daisy-chained base charger 302, according to an implementation. Each of the non-contact thermometers 102 are mated with a daisy-chain base charger 104. The daisy-chained base charger 302 is also operably coupled to a daisy-chained base charger 104. Daisy-chained base charger 302 is electrically coupled to a cord 304 which is electrically coupled to a transformer 306, the transformer including prongs (shown in FIG. 3) that are suitable for engaging a conventional electric wall outlet; so that the daisy-chained base charger 302 and the pairs 300 of the plurality of non-contact thermometers 102 placed in the daisy chained base chargers 104 will receive electric power thus providing electric power to each of the daisy-chain base chargers 104 to recharge a battery in each of the non-contact thermometers 102.

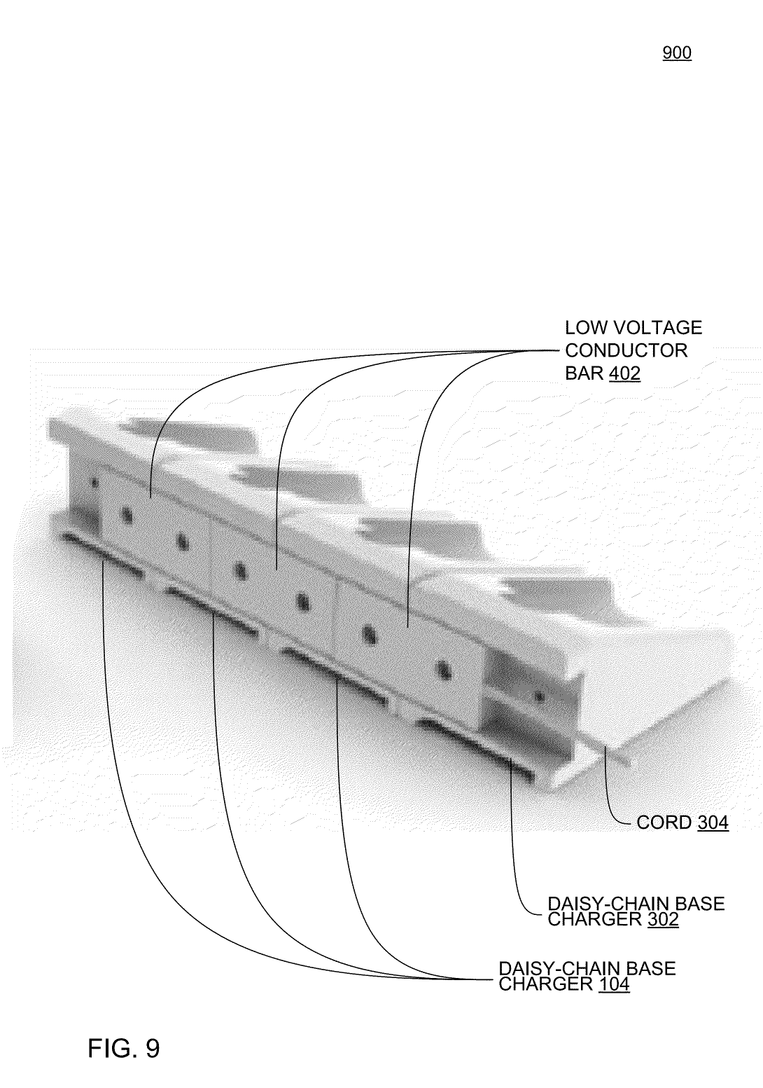

FIG. 9 is an isometric back-side view diagram of daisy-chained non-contact thermometer chargers 900, according to an implementation. Each of the daisy-chain base chargers 104 can be mated with a non-contact thermometer (not shown in FIG. 9). The daisy-chained base charger 302 is operably coupled to a daisy-chained base charger 104. The daisy-chained base chargers 104 and 302 are interconnected by a low voltage conductor bar 402 on the back of the daisy-chained base chargers 104 and 302. Power received by the daisy-chained base charger 302 through the cord 304 and the transformer 306 is transmitted from the daisy-chained base charger 302 to daisy-chained base charger(s) 104 through the low voltage conductor bar 402. Each low voltage conductor bar 402 spans and interconnects the base chargers. Daisy-chained base charger 302 is electrically coupled to a cord 304 which is electrically coupled to a transformer (306 in FIG. 3); so that the daisy-chained base charger 302 and the non-contact thermometers placed in the daisy chained base chargers 104 and 302 will receive electric power thus providing electric power to each of the daisy-chain base chargers 104 to recharge a battery in each of the non-contact thermometers.

FIG. 10 is a block diagram of apparatus 1000 to measure temperature from multiple source points, according to an implementation. A source point is an external point or position. Apparatus 1000 is handheld and battery powered for intermittent measurement and monitoring of human or animal body temperature of people of all ages. Apparatus 1000 measures electromagnetic energy emitted from multiple source points of the skin surface, such as infrared energy, of the human or animal and direct body temperature. Apparatus 1000 is operationally simple enough to be used by consumers in the household environment, yet accurate enough to be used by professional medical facilities.

Apparatus 1000 includes one or more printed circuit board(s) 1002.

Apparatus 1000 also includes a display device 1004 that is operably coupled to the one or more printed circuit board(s) 1002. Some implementations of apparatus 1000 also include a button 1006 that is operably coupled to the one or more printed circuit board(s) 1002. Apparatus 1000 also includes a battery 1008, such as a lithium ion battery, that is operably coupled to the one or more printed circuit board(s) 1002.

Apparatus 1000 also includes a non-contact sensor 1010 that is operably coupled to the one or more printed circuit board(s) 1002. The non-contact sensor 1010 detects temperature in response to remote sensing of a surface a human or animal. In some implementations, the non-contact thermometer is an infrared temperature sensor. All humans or animals radiate infrared energy. The intensity of this infrared energy depends on the temperature of the human or animal, thus the amount of infrared energy emitted by a human or animal can be interpreted as a proxy or indication of the temperature of the human or animal. The non-contact sensor 1010 measures the temperature of a human or animal based on the electromagnetic energy radiated by the human or animal. The measurement of electromagnetic energy is taken by the non-contact sensor 1010 which constantly analyzes and registers the ambient temperature. When the operator of apparatus 1000 holds the non-contact sensor 1010 about 5-8 cm (2-3 inches) from the forehead and activates the radiation sensor, the measurement is instantaneously measured. To measure a temperature using the non-contact sensor 1010, pushing the button 1006 causes a reading of temperature measurement from the non-contact sensor 1010 and the measured temperature is thereafter displayed on the display device 1004.

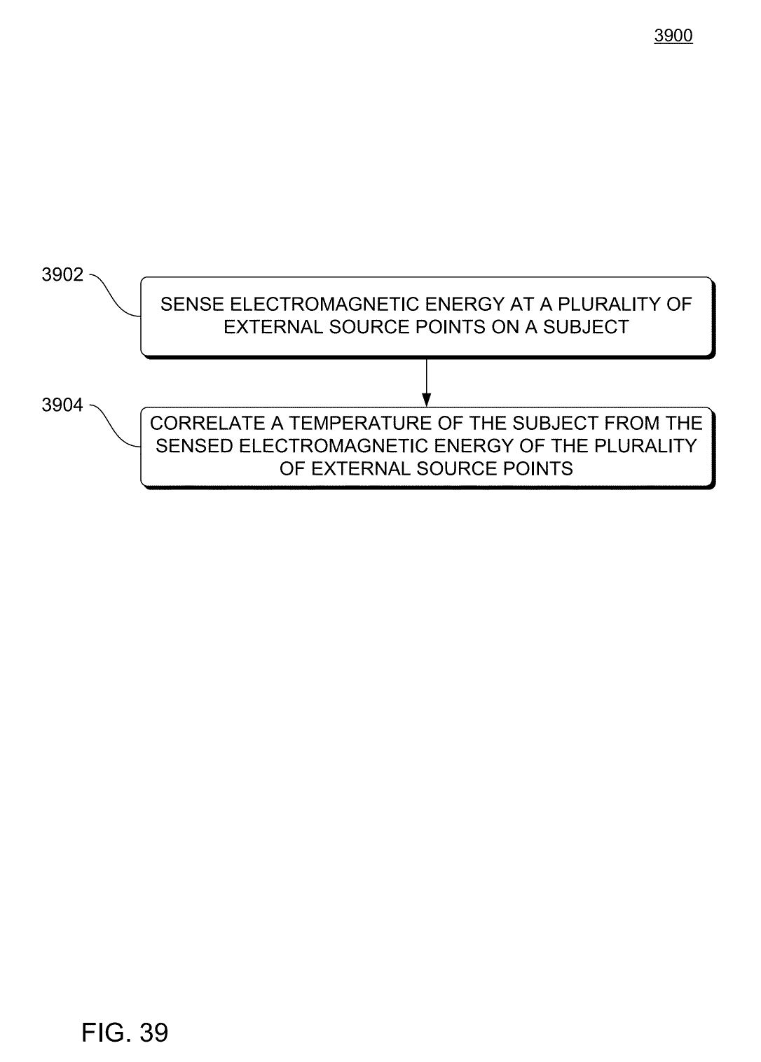

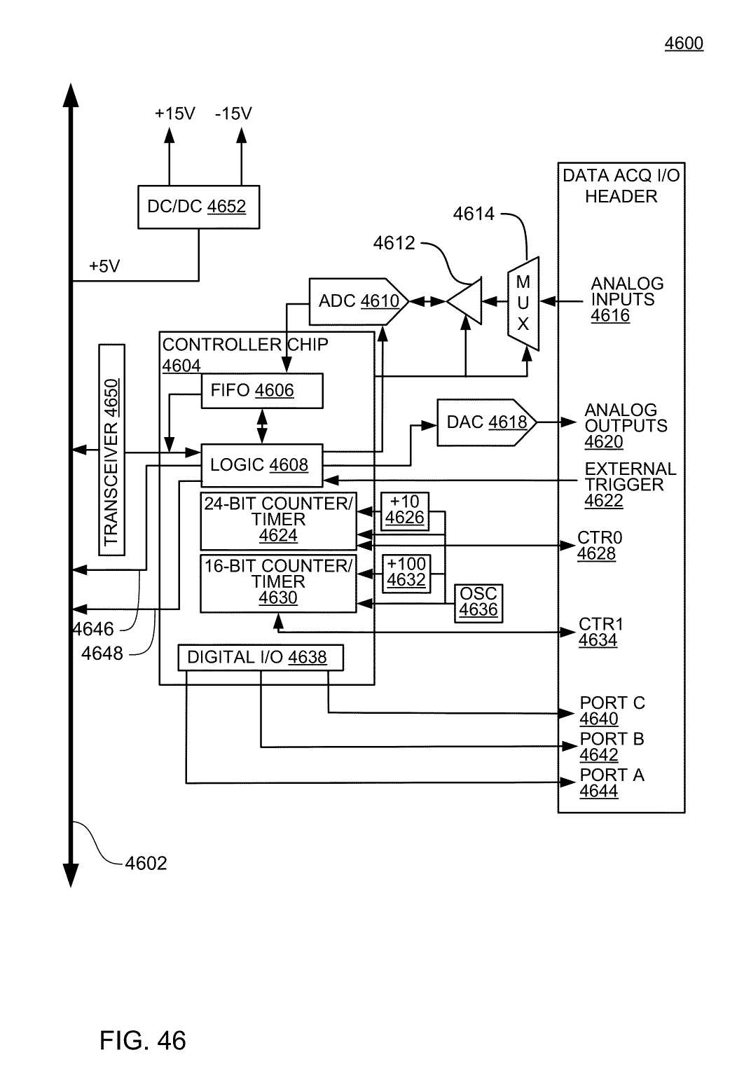

Body temperature of a human or animal can be measured in many surface locations of the body. Most commonly, temperature measurements are taken of the forehead, mouth (oral), inner ear (tympanic), armpit (axillary) or rectum. In addition, temperature measurements are taken of a carotid artery (the external carotid artery on the right side of a human neck). An ideal place to measure temperature is the forehead in addition to the carotid artery. When electromagnetic energy is sensed from two or more source points, for example, the forehead and the external carotid artery on the right side of a human neck, a multi-source temperature correlator 1012 performs one or more of the correlating actions in the methods as described in FIG. 39-42. The multi-source temperature correlator 1012 correlates the temperatures sensed by the non-contact sensor 1010 from the multiple source points (e.g. the forehead and the carotid artery) to another temperature, such as a core temperature of the subject, an axillary temperature of the subject, a rectal temperature of the subject and/or an oral temperature of the subject. The multi-source temperature correlator 1012 can be implemented as a component on a microprocessor, such as controller chip 4604 in FIG. 46 or read-only memory.

The apparatus 1000 also detects the body temperature of a human or animal regardless of the room temperature because the measured temperature of the non-contact sensor 1010 is adjusted in reference to the ambient temperature in the air in the vicinity of the apparatus. The human or animal must not have undertaken vigorous physical activity prior to temperature measurement in order to avoid a misleading high temperature. Also, the room temperature should be moderate, 50° F. to 120° F.

The non-contact thermometer 1010 provides a non-invasive and non-irritating means of measuring human or animal temperature to help ensure good health.

In some implementations, the apparatus 1000 includes only one printed circuit board 1002, in which case the printed circuit board 1002 includes not more than one printed circuit board 1002. In some implementations, the apparatus 1000 includes two printed circuit boards 1002, such as a first printed circuit board and a second printed circuit board. In some implementations, the printed circuit board(s) 1002 include a microprocessor. In some implementations, the apparatus 1000 includes only one display device 1004, in which case the display device 1004 includes not more than one display device 1004. In some implementations, the display device 1004 is a liquid-crystal diode (LCD) display device. In some implementations, the display device 1004 is a light-emitting diode (LED) display device. In some implementations, the apparatus 1000 includes only one battery 1008, which case the battery 1008 includes not more than one battery 1008.

When evaluating results, the potential for daily variations in temperature can be considered. In children less than 6 months of age daily variation is small. In children 6 months to 2 years old the variation is about 1 degree. By age 6 variations gradually increase to 2 degrees per day. In adults there is less body temperature variation.

While the apparatus 1000 is not limited to any particular printed circuit board(s) 1002, display device 1004, button 1006, battery 1008, a non-contact sensor 1010 and a multi-source temperature correlator 1012, for sake of clarity a simplified printed circuit board(s) 1002, display device 1004, button 1006, battery 1008, a non-contact sensor 1010 and a multi-source temperature correlator 1012 are described.

FIG. 11 is a block diagram of apparatus 1100 to measure temperature from a carotid source point, according to an implementation. Apparatus 1100 is handheld and battery powered for intermittent measurement and monitoring of human or animal body temperature of people of all ages. Apparatus 1100 measures electromagnetic energy, such as infrared energy, emitted from a source point of the skin surface of a carotid artery of the human or animal. Apparatus 1100 is operationally simple enough to be used by consumers in the household environment, yet accurate enough to be used by professional medical facilities.

Apparatus 1100 includes one or more printed circuit board(s) 1002 and a display device 1004 that is operably coupled to the one or more printed circuit board(s) 1002. Some implementations of apparatus 1100 also include a button 1006 that is operably coupled to the one or more printed circuit board(s) 1002. Apparatus 1100 also includes a battery 1008, such as a lithium ion battery, that is operably coupled to the one or more printed circuit board(s) 1002.

Apparatus 1100 also includes a non-contact-sensor 1010 that is operably coupled to the one or more printed circuit board(s) 1002. The non-contact-sensor 1010 detects temperature in response to remote sensing of a surface a human or animal. When the operator of apparatus 1100 holds the non-contact-sensor 1010 about 5-8 cm (2-3 inches) from the carotid artery and activates the non-contact-sensor 1010, the measurement is instantaneously measured.

When electromagnetic energy is sensed by the non-contact-sensor 1010 from the carotid artery on the right side of a human neck, a carotid temperature correlator 1102 performs one or more of the correlating actions in the methods as described in FIG. 39-41. The carotid temperature correlator 1102 correlates the temperatures sensed by the non-contact-sensor 1010 from the carotid source point to another temperature, such as a core temperature of the subject, an axillary temperature of the subject, a rectal temperature of the subject and/or an oral temperature of the subject. The carotid temperature correlator 1102 can be implemented as a component on a microprocessor, such as controller chip 4604 in FIG. 46 or read-only memory.

The apparatus 1100 also detects the body temperature of a human or animal regardless of the room temperature because the measured temperature of the non-contact-sensor 1010 is adjusted in reference to the ambient temperature in the air in the vicinity of the apparatus 1100. The human or animal must not have undertaken vigorous physical activity prior to temperature measurement in order to avoid a misleading high temperature. Also, the room temperature should be moderate, 50° F. to 120° F.

In some implementations, the apparatus 1100 includes only one printed circuit board 1002, in which case the printed circuit board 1002 includes not more than one printed circuit board 1002. In some implementations, the apparatus 1100 includes two printed circuit boards 1002, such as a first printed circuit board and a second printed circuit board. In some implementations, the printed circuit board(s) 1002 include a microprocessor. In some implementations, the apparatus 1100 includes only one display device 1004, in which case the display device 1004 includes not more than one display device 1004. In some implementations, the display device 1004 is a liquid-crystal diode (LCD) display device. In some implementations, the display device 1004 is a light-emitting diode (LED) display device. In some implementations, the apparatus 1100 includes only one battery 1008, which case the battery 1008 includes not more than one battery 1008.

While the apparatus 1100 is not limited to any particular printed circuit board(s) 1002, display device 1004, button 1006, battery 1008, a non-contact-sensor 1010 and a carotid temperature correlator 1102, for sake of clarity a simplified printed circuit board(s) 1002, display device 1004, button 1006, battery 1008, a non-contact-sensor 1010 and a carotid temperature correlator 1102 are described.

FIG. 12 is an isometric top-view block diagram of an apparatus 1200 to measure temperature using both a non-contact thermometer with a right-angled waveguide and not including a contact thermometer, according to an implementation. Apparatus 1200 is handheld and battery powered for intermittent measurement and monitoring of human or animal body temperature of people of all ages. Apparatus 1200 measures non-contact infrared energy emitted from the skin surface of the human or animal. Apparatus 1200 can be used by consumers in the household environment.

Apparatus 1200 includes the display device 1004 that is mounted on the exterior of a body 1202 or other housing of the apparatus 1200. Apparatus 1200 also includes the button 1006 that is mounted on the exterior of the body 1202 or other housing of the apparatus 1200. Apparatus 1200 also includes a sensor 1203 of the non-contact sensor 1010, the sensor 1203 being mounted in the interior of the body 1202 of the apparatus 1200. The non-contact sensor 1010 detects temperature in response to remote sensing of a surface a human or animal. The right-angled waveguide 1218 is positioned in proximity to the sensor 1204. The right-angled waveguide 1218 includes at least one flat planar surface. The apparatus 1200 includes 4 flat planar surfaces 1206, 1208, 1210 and 1212.

Apparatus 1200 also includes a mode button 1212 that when pressed by an operator toggles or switches between three different detection modes, a first detection mode being detection and display of surface temperature, a second detection mode being detection and display of body temperature and a third detection mode being detection and display of room temperature.

Apparatus 1200 also includes a temperature button 1214 that when pressed by an operator toggles or switches between two different temperature modes, a first temperature mode being display of temperature in Celsius and a second temperature mode being display of temperature in Fahrenheit.

Apparatus 1200 also includes a memory button 1216 that when pressed by an operator toggles or switches between a plurality of past temperature readings. In one implementation, the plurality of past temperature readings is 32.

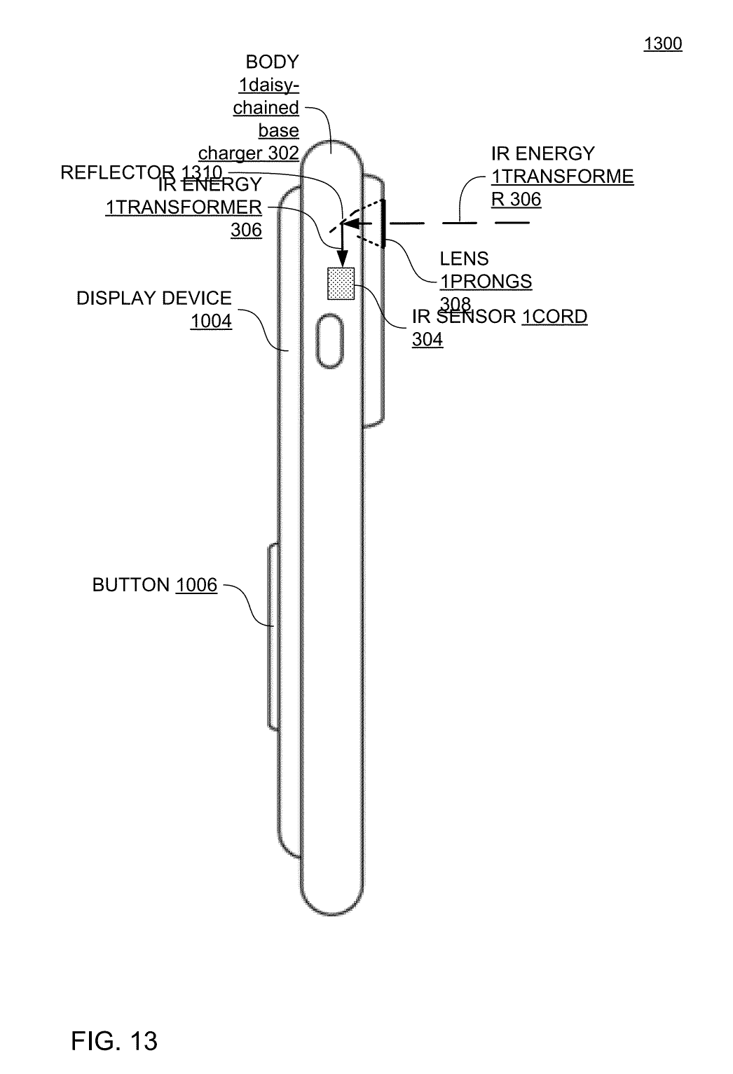

FIG. 13 is a side-view block diagram of an apparatus 1300 to measure temperature using a non-contact thermometer with a right-angled waveguide, according to an implementation. Apparatus 1300 is handheld and battery powered for intermittent measurement and monitoring of human or animal body temperature of people of all ages. Apparatus 1300 measures non-contact infrared energy emitted from the skin surface of the human or animal. Apparatus 1300 can be used by consumers in the household environment.

Apparatus 1300 includes the display device 1004 that is mounted on the exterior of a body 1302 or other housing of the apparatus 1300. Apparatus 1300 also includes the button 1006 that is mounted on the exterior of the body 1302 or other housing of the apparatus 1300.

Apparatus 1300 includes the non-contact sensor having an infrared sensor 1304. The infrared sensor 1304 is operable to receive infrared energy 1306 via a pathway to the infrared sensor 1304. Apparatus 1300 includes a lens 1308 that is positioned over the pathway. In some implementations, the lens 1308 has only right-angled edges, the lens 1308 being square in geometry, that is transverse to the pathway to the infrared sensor 1306. The pathway intersects the lens 1308. A reflector 1310 that is positioned at a 45 degree angle to the infrared sensor 1304. The lens 1308 has a longitudinal axis that is perpendicular to a longitudinal axis of the infrared sensor. The reflector 1310 is positioned at a 45 degree angle to the lens 1304. The pathway is coincident to the IR energy 1306 that passes through the lens 1308, reflects off of the reflector 1310 and to the IR sensor 1304.

Apparatus 1300 also includes the sensor 303 of the non-contact sensor 1010, the sensor 303 being mounted in the interior of the body 302 of the apparatus 1300. The non-contact sensor 1010 detects temperature in response to remote sensing of a surface of a human or animal. The contact sensor 1312 detects temperature in response to direct contact with the human or animal. The dual sensors 1010 and 1312 provide improved convenience and heightened accuracy in detecting temperatures in humans or animals. In some situations, the non-contact thermometer 1010 is used as initial instrument of temperature detection of a human or animal and the contact sensor 1312 is used as a second instrument of temperature detection of the human or animal.

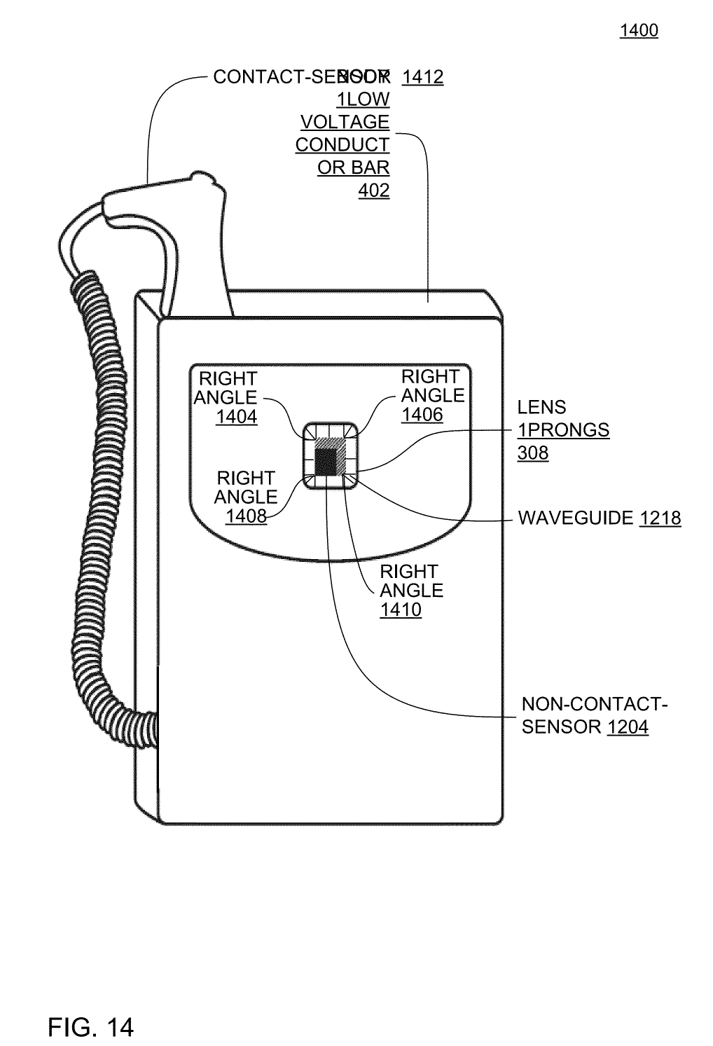

FIG. 14 is an isometric block diagram of an apparatus 1400 to measure temperature using both non-contact thermometer with a right-angled waveguide and a contact thermometer, according to an implementation. Apparatus 1400 is handheld and battery powered for intermittent measurement and monitoring of human or animal body temperature of people of all ages. Apparatus 1400 measures both infrared energy emitted from the skin surface of the human or animal and direct body temperature. Apparatus 1400 can be used by consumers in the household environment.

Apparatus 1400 includes the display device 1004 that is mounted on the exterior of a body 1402 of the apparatus 1400. Apparatus 1400 also includes the button 1006 that is mounted on the exterior of the body 1402 of the apparatus 1400. Apparatus 1400 also includes a lens 1304 of the non-contact sensor 1010, the lens 1304 being mounted on the exterior of the body 1402 of the apparatus 1400. The non-contact sensor 1010 behind the lens 1404 detects temperature in response to remote sensing of a surface a human or animal. A right-angled waveguide 318 is positioned in proximity to the non-contact thermometer 1010. The right-angled waveguide 318 includes at least one flat planar surface and right angles 1404, 1406, 1408 and 1410. Apparatus 1400 also includes the contact sensor 1312 that is mounted on the exterior of the body 1402 of the apparatus 1400. The contact sensor 1312 detects temperature in response to direct contact with the human or animal. The dual sensors 1010 and 1312 provide both convenience and heightened accuracy in detecting temperatures in humans or animals. In some situations, the non-contact thermometer 1010 is used as an initial instrument of temperature detection of a human or animal and the contact sensor 1312 is used as a second instrument of temperature detection of the human or animal.

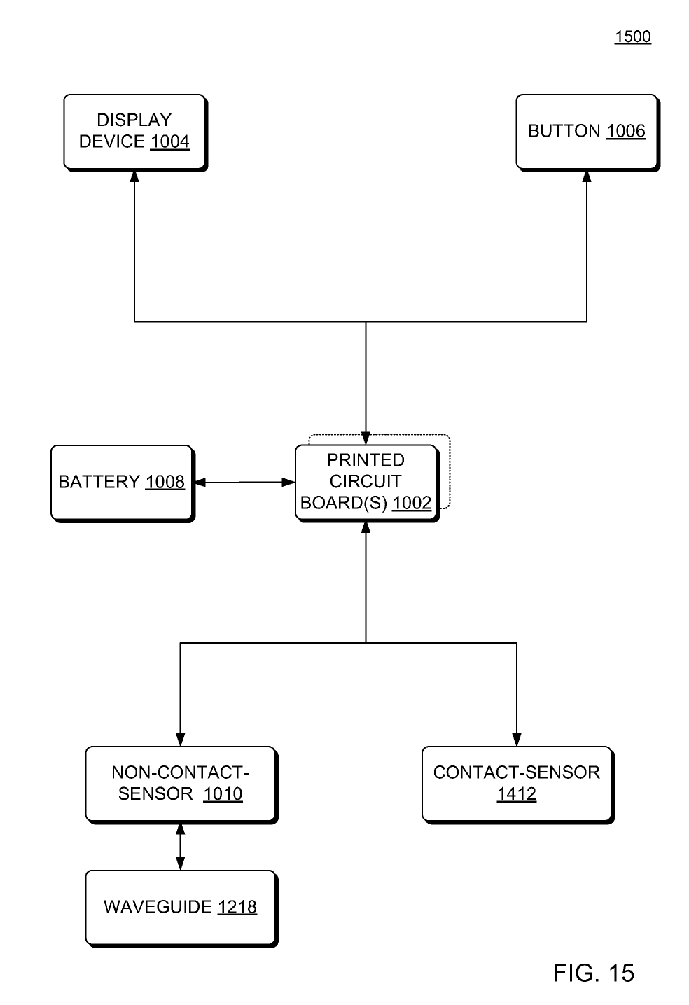

FIG. 15 is a block diagram of apparatus 1500 to measure temperature, according to an implementation. Apparatus 1500 is handheld and battery powered for intermittent measurement and monitoring of human or animal body temperature of people of all ages. Apparatus 1500 measures both electromagnetic energy emitted from the skin surface, such as infrared energy, of the human or animal and direct body temperature. Apparatus 1500 is operationally simple enough to be used by consumers in the household environment, yet accurate enough to be used by professional medical facilities.

Apparatus 1500 includes one or more printed circuit board(s) 1002.

Apparatus 1500 also includes a display device 1004 that is operably coupled to the one or more printed circuit board(s) 1002. Some implementations of apparatus 1500 also include a button 1006 that is operably coupled to the one or more printed circuit board(s) 1002. Apparatus 1500 also includes a battery 1008, such as a lithium ion battery, that is operably coupled to the one or more printed circuit board(s) 1002.

Apparatus 1500 also includes a non-contact sensor 1010 that is operably coupled to the one or more printed circuit board(s) 1002. The non-contact sensor 1010 detects temperature in response to remote sensing of a surface a human or animal. In some implementations the non-contact thermometer is an infrared temperature sensor.

Some implementations of apparatus 1500 also include a contact sensor 1312 that is operably coupled to the one or more printed circuit board(s) 1002. The contact sensor 1312 detects temperature in response to direct contact with a human or animal.

A right-angled waveguide 318 is positioned in proximity to the non-contact thermometer 1010. The geometry of the right-angled waveguide 318 has at least one right-angle and at least flat planar surface. In some implementations, the geometry of the right-angled waveguide 318 has only right-angled edges. In general, a waveguide is a structure of a passageway or pathway which guides waves, such as electromagnetic waves. Waves in open space propagate in all directions, as spherical waves. In this way the wave lose power proportionally to the square of the distance; that is, at a distance R from the source, the power is the source power divided by R2. The waveguide confines the wave to propagation in one dimension, so that (under ideal conditions) the wave loses no power while propagating. Waves are confined inside the waveguide due to total reflection from the waveguide wall, so that the propagation inside the waveguide can be described approximately as a “zigzag” between the walls. There are different types of waveguides for each type of wave. The original and most common implementation of a waveguide is a hollow conductive metal pipe used to carry high frequency radio waves, particularly microwaves. Waveguides differ in their geometry which can confine energy in one dimension such as in slab waveguides or a waveguide can confine energy in two dimensions as in fiber or channel waveguides. As a rule of thumb, the width of a waveguide needs to be of the same order of magnitude as the wavelength of the guided wave.

A conventional geometry of a waveguide has a circular cross-section, which is most useful for gathering electromagnetic waves that have a rotating, circular polarization in which the electrical field traces out a helical pattern as a function of time. However, infrared energy emitted from a surface of a human does not have a rotating, circular polarization in which the electrical field traces out a helical pattern as a function of time. Therefore, in apparatus that measures infrared energy of a human as a proxy of temperature of the human, circular and rounded waveguides should not be used. The waveguide 318 is not conical in geometry because a conical waveguide reflects the electromagnetic waves in a somewhat incoherent manner in which the electromagnetic waves are received at the sensor with a decreased degree of coherency, thus decreasing the signal strength; and the conical waveguide reflects a significant portion of electromagnetic waves out of the waveguide and away from the sensor, thus further reducing the signal strength of the electromagnetic waves received by the sensor and therefore further reducing the accuracy and speed of the non-contact temperature sensing. More specifically, waveguide 318 is not a conical funnel in which the conical funnel has an opening at one end of a longitudinal axis that has a larger diameter than an opening at the other end of the longitudinal axis.

The dual sensors 1010 and 1312 provide improved convenience and heightened accuracy in detecting temperatures in humans or animals. In some situations, the non-contact thermometer 1010 is used as an initial instrument of temperature detection of a human or animal and the contact sensor 1312 is used as a second instrument of temperature detection of the human or animal. The non-contact sensor 1010 eliminates need for contact with the skin, yet the contact sensor 1312 provides a more accurate detection of human or animal body temperature to supplement or verify the temperature detected by the non-contact thermometer 1010.

In some implementations, the apparatus 1500 includes only one printed circuit board 1002, in which case the printed circuit board 1002 includes not more than one printed circuit board 1002. In some implementations, the apparatus 1500 includes two printed circuit boards 1002, such as a first printed circuit board and a second printed circuit board. In some implementations, the printed circuit board(s) 1002 include a microprocessor. In some implementations, the apparatus 1500 includes only one display device 1004, in which case the display device 1004 includes not more than one display device 1004. In some implementations, the display device 1004 is a liquid-crystal diode (LCD) display device. In some implementations, the display device 1004 is a light-emitting diode (LED) display device. In some implementations, the apparatus 1500 includes only one battery 1008, which case the battery 1008 includes not more than one battery 1008.

While the apparatus 1500 is not limited to any particular printed circuit board(s) 1002, display device 1004, button 1006, battery 1008, non-contact sensor 1010 and a contact sensor 10312, for sake of clarity a simplified printed circuit board(s) 1002, display device 1004, button 1006, battery 1008, non-contact sensor 1010 and a contact sensor 1312 are described.

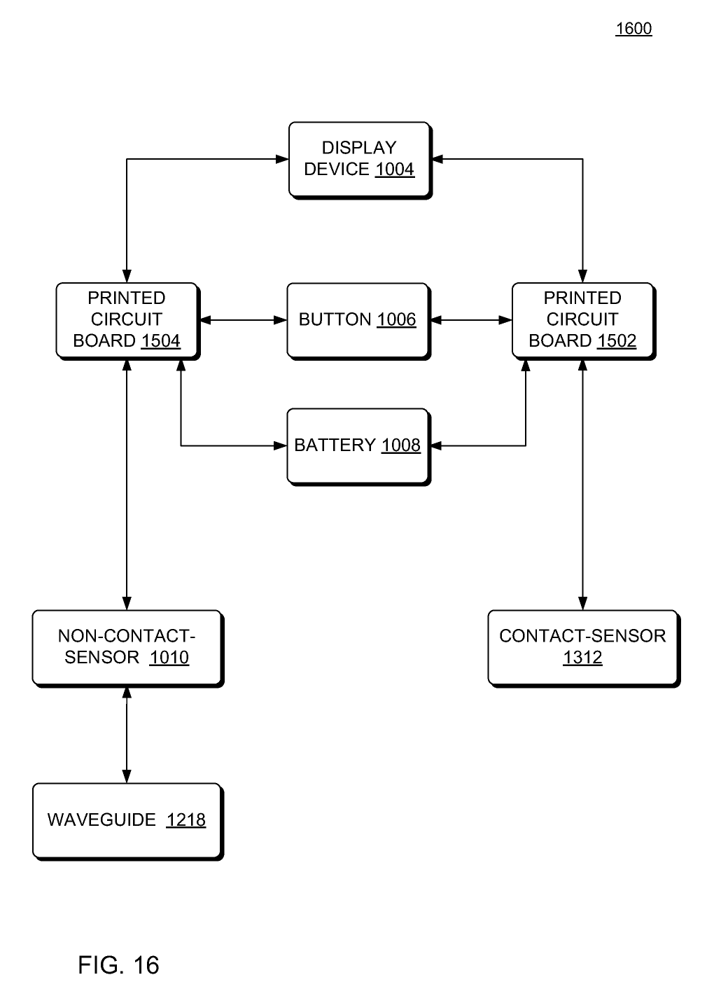

FIG. 16 is a block diagram of apparatus 1600 to measure temperature, according to an implementation in which each of a non-contact thermometer and a contact thermometer are controlled by a separate printed circuit board and the non-contact thermometer has a right-angled waveguide, according to an implementation.

Apparatus 1600 includes the contact sensor 1312 that is operably coupled to a first printed circuit board 1602, a non-contact sensor 1010 that is operably coupled to a second printed circuit board 1604, the display device 1004 that is operably coupled to the first printed circuit board 1602 and the second printed circuit board 1604, the button 1006 that is operably coupled to the first printed circuit board 1602 and the second printed circuit board 1604 and the battery 1008 that is operably coupled to the first printed circuit board 1602 and the second printed circuit board 1604. In apparatus 1600, the display device 1004, the button 1006 and the battery 1008 are shared, but each thermometer has a dedicated printed circuit board.

A right-angled waveguide 318 is positioned in proximity to the non-contact thermometer 1010. The geometry of the right-angled waveguide 318 has at least one right-angle. In some implementations, the geometry of the right-angled waveguide 318 has only right-angled edges.

Some implementations of apparatus in FIG. 10-15 include an ambient air temperature sensor that is operably coupled to, or a part of, the printed circuit board(s) 102, 1602 or 1604.

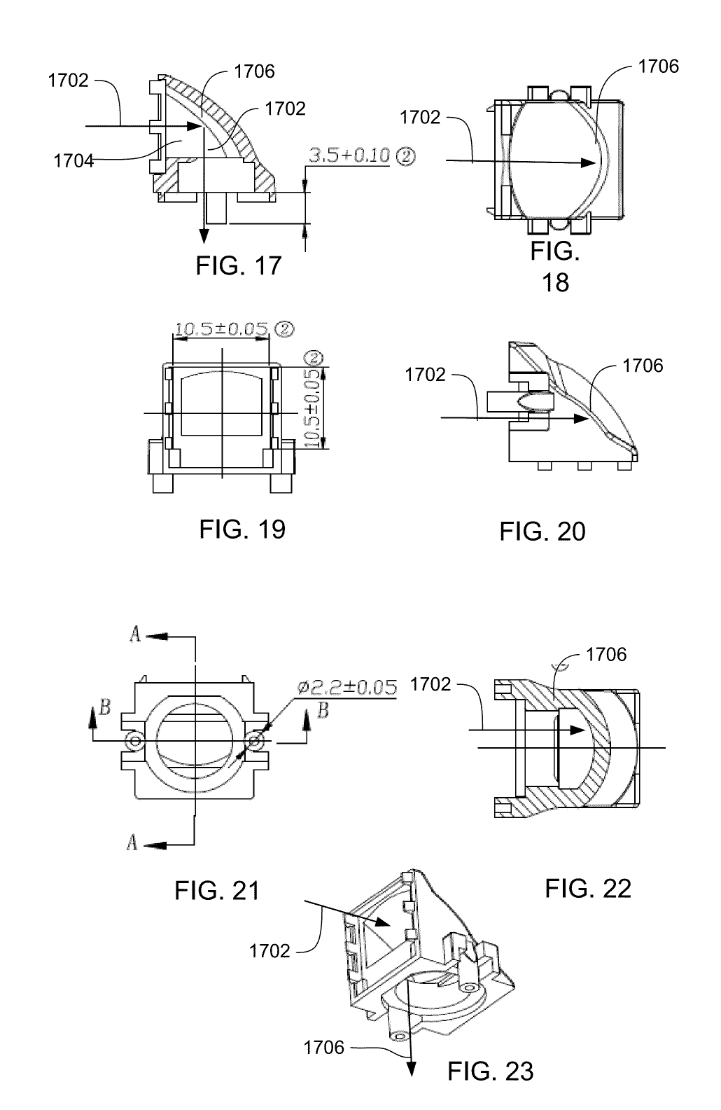

FIG. 17-23 are block diagrams of a sensor collector to guide electromagnetic energy to measure temperature, according to an implementation. FIG. 17 is a side cut-away view of the sensor collector to guide electromagnetic energy. The electromagnetic energy 1702 enters the cavity 1704 of the sensor collector and reflects off of the shroud 1706 and through the bottom opening. The shroud 1706 has in an inside surface that is concave. The shroud 1706 is one example of the reflector 1310 in FIG. 13. FIG. 18 is a top view of the sensor collector to guide electromagnetic energy. FIG. 19 is a front view of the sensor collector to guide electromagnetic energy. FIG. 20 is a side view of the sensor collector to guide electromagnetic energy. FIG. 21 is a bottom view of the sensor collector to guide electromagnetic energy. FIG. 22 is a top cut-away view of the sensor collector to guide electromagnetic energy. FIG. 23 is a bottom isometric view of the sensor collector to guide electromagnetic energy.

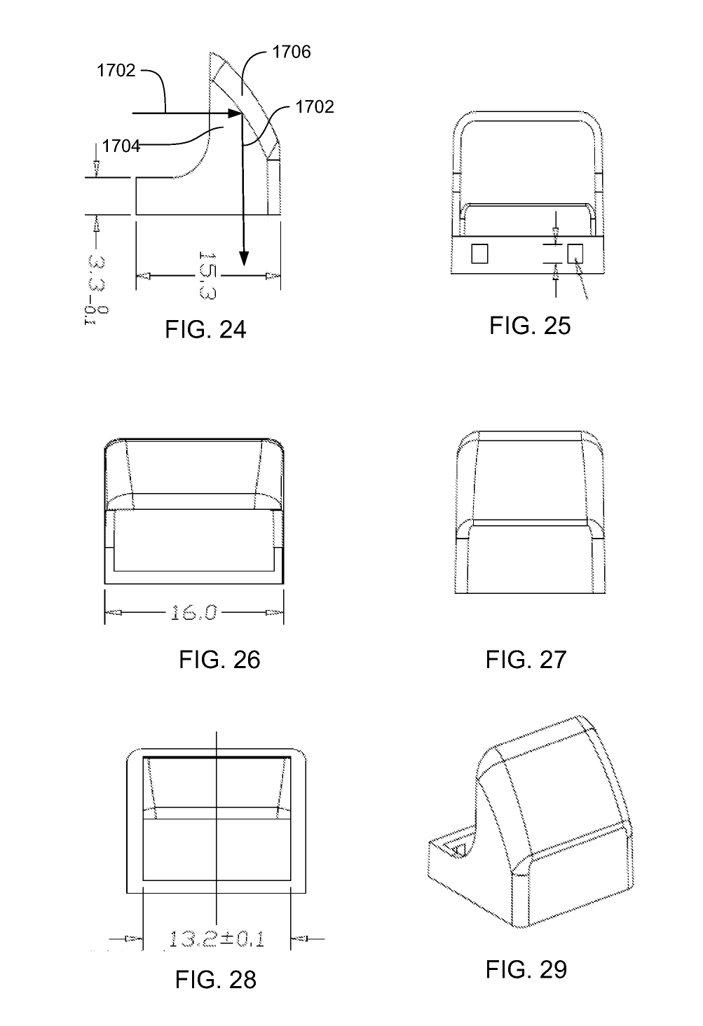

FIG. 24-29 are block diagrams of a shroud of a sensor collector to guide electromagnetic energy to measure temperature, according to an implementation. FIG. 24 is a side view of a shroud of a sensor collector to guide electromagnetic energy. The electromagnetic energy 1702 enters the cavity 1704 of the sensor collector and reflects off of the shroud 1706 and through the bottom opening. FIG. 25 is a bottom view of a shroud of a sensor collector to guide electromagnetic energy. FIG. 26 is a front cut-away view of a shroud of a sensor collector to guide electromagnetic energy. FIG. 27 is a front view of a shroud of a sensor collector to guide electromagnetic energy. FIG. 28 is a front cut-away view of a shroud of a sensor collector to guide electromagnetic energy. FIG. 29 is a back top isometric view of a shroud of a sensor collector to guide electromagnetic energy.

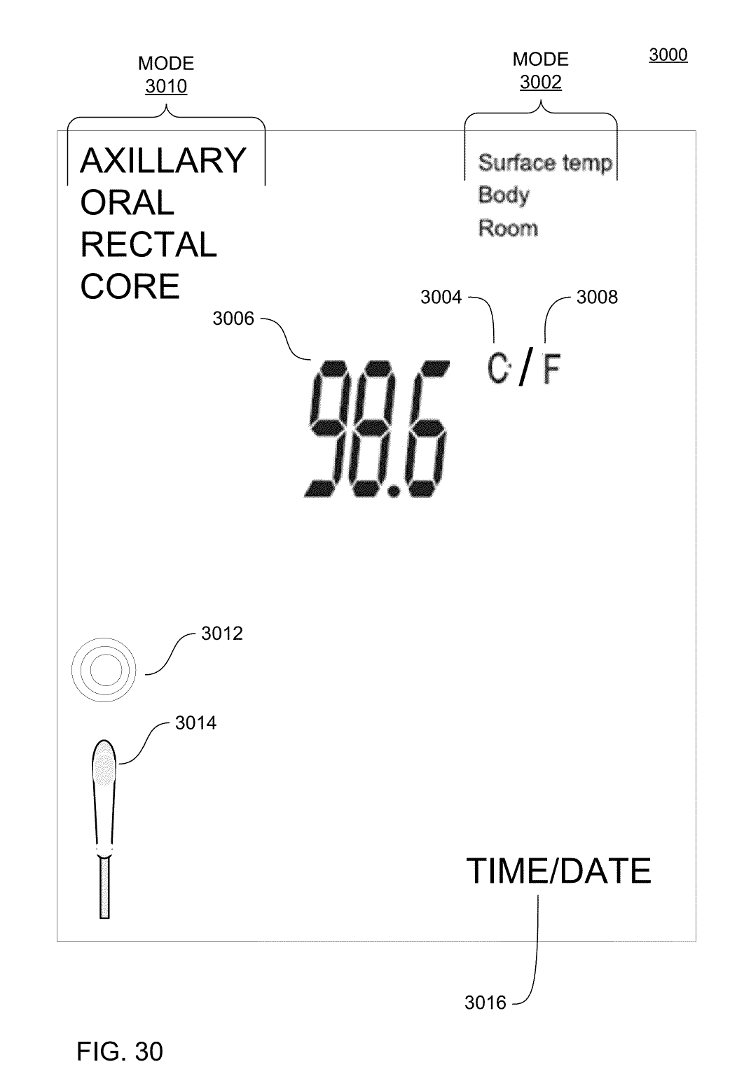

FIG. 30 is a representation of display that is presented on the display device of apparatus in FIG. 10-15, according to an implementation that manages both a non-contact sensor and a contact sensor.

Some implementations of display 3000 include a representation of three detection modes 3002, a first detection mode being detection and display of surface temperature, a second detection mode being detection and display of body temperature and a third detection mode being detection and display of room temperature.

Some implementations of display 3000 include a representation of Celsius 3004 that is activated when the apparatus is in Celsius mode.

Some implementations of display 3000 include a representation of a sensed temperature 3006.

Some implementations of display 3000 include a representation of Fahrenheit 3008 that is activated when the apparatus is in Fahrenheit mode.

Some implementations of display 3000 include a representation of a mode 3010 of site temperature sensing, a first site mode being detection of an axillary surface temperature, a second site mode being detection of an oral temperature, a third site mode being detection of a rectal temperature and a fourth site mode being detection of a core temperature.

Some implementations of display 3000 include a representation of a scanner mode 3012 that is activated when the sensed temperature 3006 is from a non-contact sensor 1010.

Some implementations of display 3000 include a representation of a probe mode 3014 that is activated when the sensed temperature 3006 is from a contact sensor 1312.

Some implementations of display 3000 include a representation of the current time/date 3016 of the apparatus.

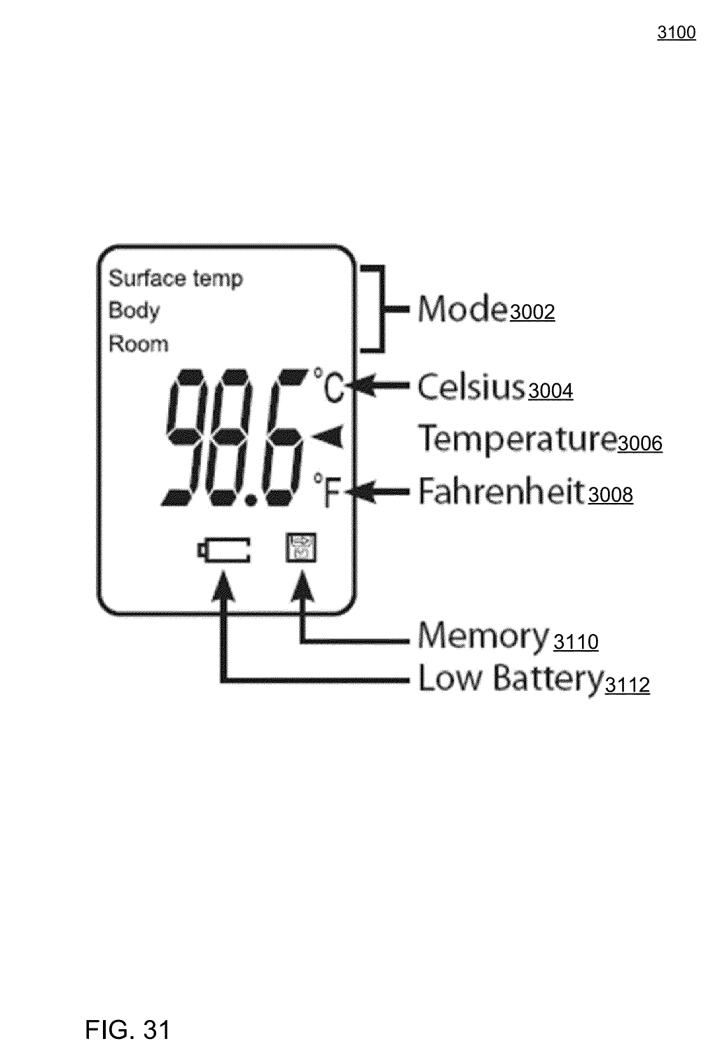

FIG. 31 is a representation of display 3100 that is presented on the display device of apparatus in FIG. 10-15, according to an implementation.

Some implementations of display 3100 include a representation of three detection modes 3002, a first detection mode being detection and display of surface temperature, a second detection mode being detection and display of body temperature and a third detection mode being detection and display of room temperature.

Some implementations of display 3100 include a representation of Celsius 3004 that is activated when the apparatus is in Celsius mode.

Some implementations of display 3100 include a representation of a temperature 3006.

Some implementations of display 3100 include a representation of Fahrenheit 3008 that is activated when the apparatus is in Fahrenheit mode.

Some implementations of display 3100 include a representation of memory 3110.

Some implementations of display 3100 include a representation of battery charge level 3112.

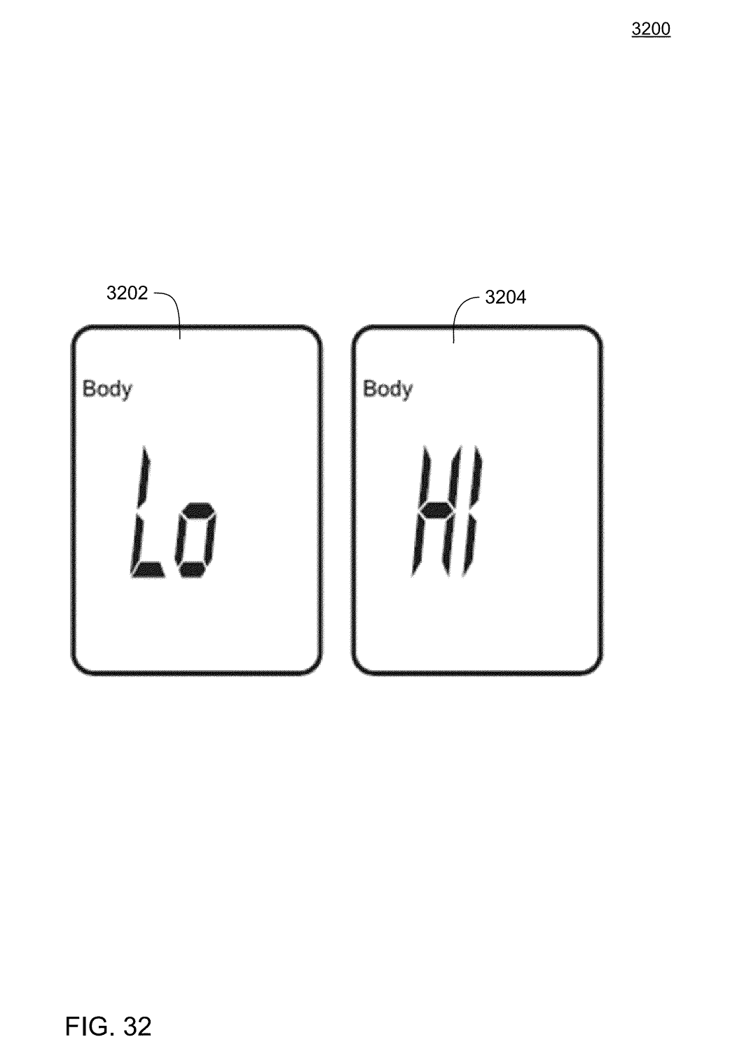

FIG. 32 is a representation of text displays 3200 that are presented on the display device of apparatus in FIG. 10-15, according to an implementation. Some implementations of display 3200 include a text representation that a sensed body temperature 3202 is “Lo” as in “low”. Some implementations of display 3200 include a text representation that a sensed body temperature 3204 is “Hi” as in “high”.

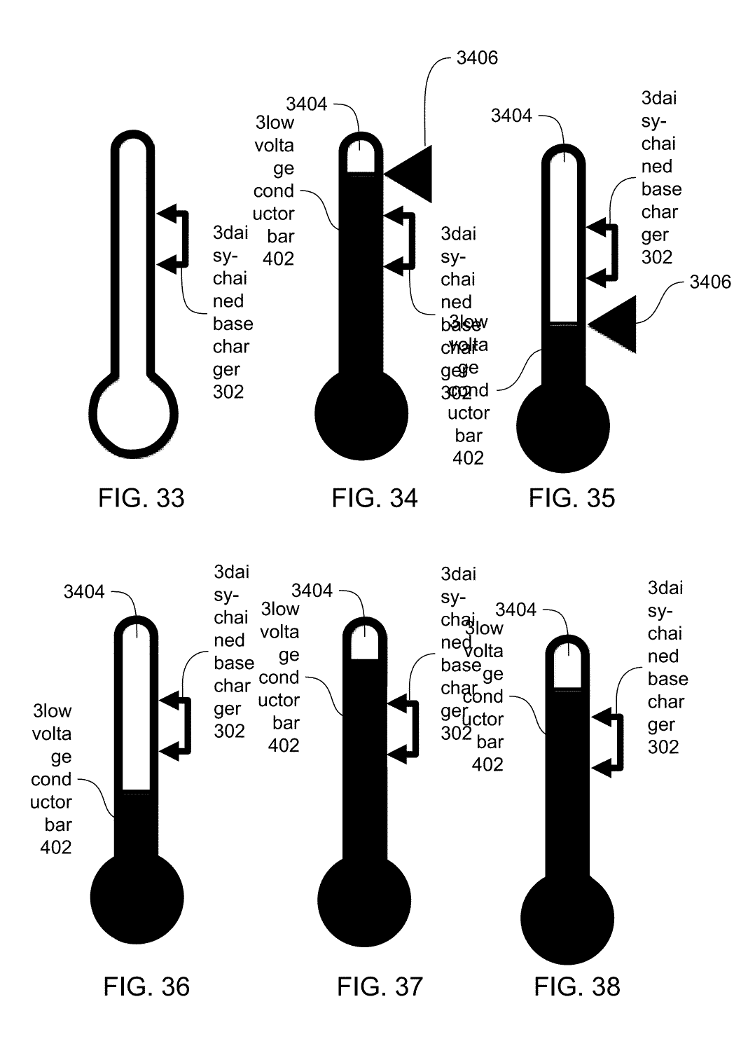

FIG. 33-38 are representations of graphical displays that are presented on the display device of apparatus in FIG. 10-15, according to implementations. The double-arrow bracket 3302 in FIG. 33-38 represents a general range of normal temperatures.

FIG. 33 is a graphical display that represents a state of having no sensed temperature. The empty thermometer in FIG. 33 indicates that no temperature sensing activity has completed.

FIG. 34 is a graphical display that represents a state of having sensed a high temperature. The thermometer in FIG. 34 having a contrasting color 3402 that is located above the general ranges of normal temperature indicates a higher than normal temperature. In FIG. 34-39, the contrasting color 3402 contrasts to the remainder 3404 of the interior of the thermometer image. In the example shown in FIG. 34-38, the contrasting color 3402 is black which contrasts with the white of the remainder 3404 of the interior of the thermometer image. FIG. 34 includes a pointer 3406 indicating the sensed temperature.

FIG. 35 is a graphical display that represents a state of having sensed a low temperature. The thermometer in FIG. 35 having only a contrasting color that is located below the general ranges of normal temperature indicates a lower than normal temperature. FIG. 35 includes a pointer 3406 indicating the sensed temperature.

FIG. 36 is a graphical display that represents a state of having sensed a low temperature. The thermometer in FIG. 36 having contrasting color located only below the general ranges of normal temperature indicates a lower than normal temperature.

FIG. 37 is a graphical display that represents a state of having sensed a high temperature. The thermometer in FIG. 37 having contrasting color that is located above the general ranges of normal temperature indicates a higher than normal temperature.

FIG. 38 is a graphical display that represents a state of having sensed a high temperature. The thermometer in FIG. 38 having contrasting color that is located above the general ranges of normal temperature indicates a higher than normal temperature.

Use Cases of Apparatus

In one example of use of the apparatus shown in FIG. 10-15, an operator performs a scan with the non-contact thermometer 1010, the operator determines that a contact temperature is helpful or necessary and the operator performs a reading with a contact sensor 1312. In another example of use of the apparatus shown in FIG. 10-15, the operator performs a reading with the contact sensor 1312, the operator determines that a non-contact temperature is helpful or necessary and the operator performs a scan with the non-contact thermometer 1010.

To perform a scan with the non-contact thermometer 1010, the operator uses a button to select one three modes of the apparatus, 1) oral 2) rectal or 4) axillary. The operator pushes the scan button 1006 to initiate a non-contact temperature scan. The apparatus displays the detected temperature that is calculated in reference to the selected mode.

To determine that a contact temperature is helpful or necessary, the operator reviews the temperature displayed by the apparatus and determines that a temperature reading using a different technique, such as either contact or non-contact) would be informative.

To perform a reading with the contact sensor 1312, the operator removes a contact sensor 1312 probe from a receiver and places a disposable probe cover over the contact sensor 1312, and the operator inserts the probe of the contact sensor 1312 into the mouth of a human or animal. The apparatus senses in increase in temperature through the contact sensor 1312 and in response the apparatus starts a timer. After expiration of the timer, the apparatus displays on the display device 1004 the sensed temperature at the time of the timer expiration and generates an audio alert and in response the operator removes the probe of the contact sensor 1312 from the mouth of the human or animal, places the probe of the contact sensor 1312 into the receiver and reads the displayed temperature on the display device 1004.

### Method Implementations

In the previous section, apparatus of the operation of an implementation was described. In this section, the particular methods performed by apparatus 1000, 1100, 1300, 1400 and 1600 of such an implementation are described by reference to a series of flowcharts.

FIG. 39 is a flowchart of a method 3900 to measure temperature from multiple source points. Method 3900 includes sensing electromagnetic energy at a plurality of external source points on a subject, at block 3902. The sensing at block 3900 yields a sensed electromagnetic energy of the plurality of external source points. In one implementation, block 3902 includes sensing the electromagnetic energy from only at the carotid artery source point on the subject and sensing the electromagnetic energy at no other point on the subject.

Method 3900 also includes correlating a temperature of the subject from the sensed electromagnetic energy of the plurality of external source points, at block 3904. The correlating at block 3904 yields a correlated temperature. In some implementations, the correlating at block 3904 is performed by the multi-source temperature correlator 1012 in FIG. 10. In some implementations, block 3904 includes correlating only the temperature of the subject from the sensed electromagnetic energy of the carotid artery source point on the subject. In one implementation, block 3904 includes correlating the electromagnetic energy from only the carotid artery source point on the subject and correlating the electromagnetic energy at no other point on the subject.

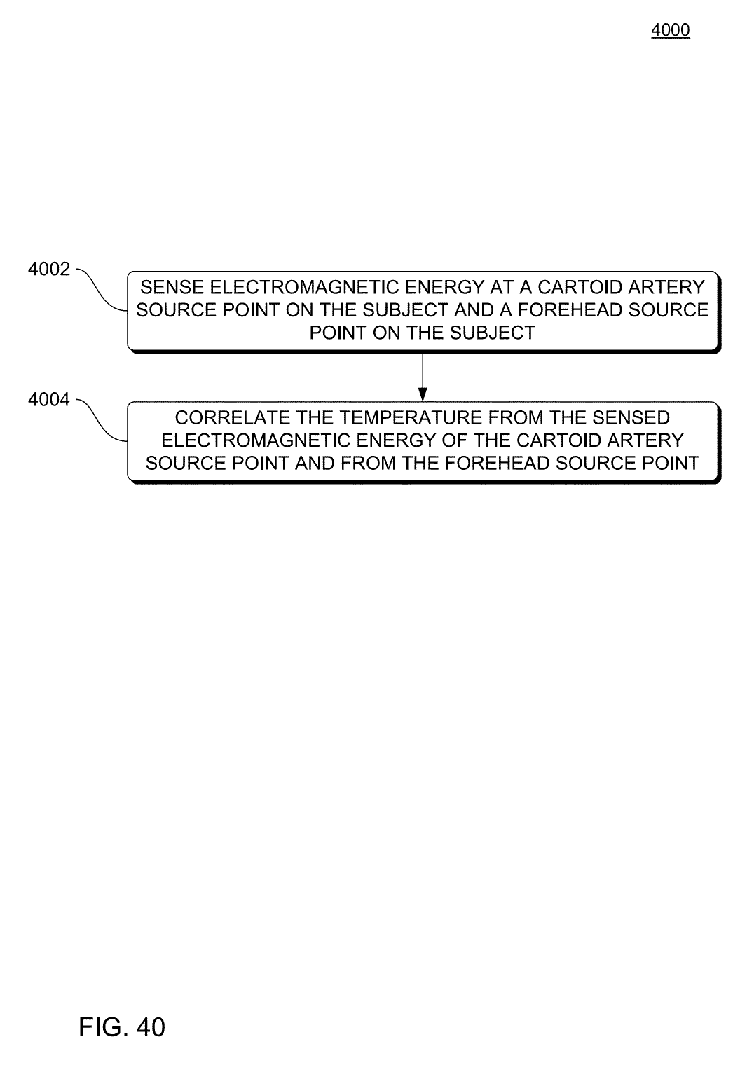

FIG. 40 is a flowchart of a method 4000 to measure temperature of a forehead and a carotid artery, according to an implementation. Method 4000 includes sensing the electromagnetic energy at the carotid artery source point on the subject and/or the forehead source point on the subject, at block 4002. In one implementation, block 4002 includes sensing the electromagnetic energy from only at the carotid artery source point on the subject and sensing the electromagnetic energy at no other point on the subject. The sensing at block 4002 yields the sensed electromagnetic energy of the external source point(s).

Method 4000 also includes correlating the temperature of the subject from the sensed electromagnetic energy of the carotid artery source point on the subject and/or from the forehead source point on the subject, at block 4004. The correlating at block 4004 yields a correlated temperature. In some implementations, block 4004 includes correlating only the temperature of the subject from the sensed electromagnetic energy of the carotid artery source point on the subject. In some implementations, the correlating at block 4004 is performed by the multi-source temperature correlator 1012 in FIG. 10. In one implementation, block 4004 includes correlating the electromagnetic energy from only the carotid artery source point on the subject and correlating the electromagnetic energy at no other point on the subject.

In some implementations of method 3900 and 4000, the correlated temperature of the subject includes only a core temperature of the subject, an axillary temperature of the subject, a rectal temperature of the subject and an oral temperature of the subject. Methods 3900 and 4000 permit an operator to take the temperature of a subject at multiple locations on a patient and from the temperatures at multiple locations to determine the temperature at a number of other locations of the subject. The multiple source points of which the electromagnetic energy is sensed are mutually exclusive to the location of the correlated temperature. In one example, the carotid artery source point on the subject and a forehead source point are mutually exclusive to the core temperature of the subject, an axillary temperature of the subject, a rectal temperature of the subject and an oral temperature of the subject.

The correlation of action 3904 in FIG. 39 and action 4004 can include a calculation based on Formula 1:

T_{body}=|f_{stb}(T_{surface temp}+f_{ntc}(T_{ntc}))+F4_{body}| Formula 1
where T_{body} is the temperature of a body or subject
where f_{stb} is a mathematical formula of a surface of a body
where f_{ntc} is mathematical formula for ambient temperature reading
where T_{surface temp} is a surface temperature determined from the sensing 3902 in FIG. 3900 or 4002 in FIG. 40.
where T_{ntc} is an ambient air temperature reading
where F4_{body} is a calibration difference in axillary mode, which is stored or set in a memory of the apparatus either during manufacturing or in the field. The apparatus also sets, stores and retrieves F4ₒᵣₐₗ, F4_{core}, and F4_{rectal} in the memory.
f_{ntc}(T_{ntc}) is a bias in consideration of the temperature sensing mode. For example f_{axilary}(T_{axilary})=0.2° C., fₒᵣₐₗ(Tₒᵣₐₗ)=0.4° C., f_{rectal}(T_{rectal})=0.5° C. and f_{core}(T_{core})=0.3° C.

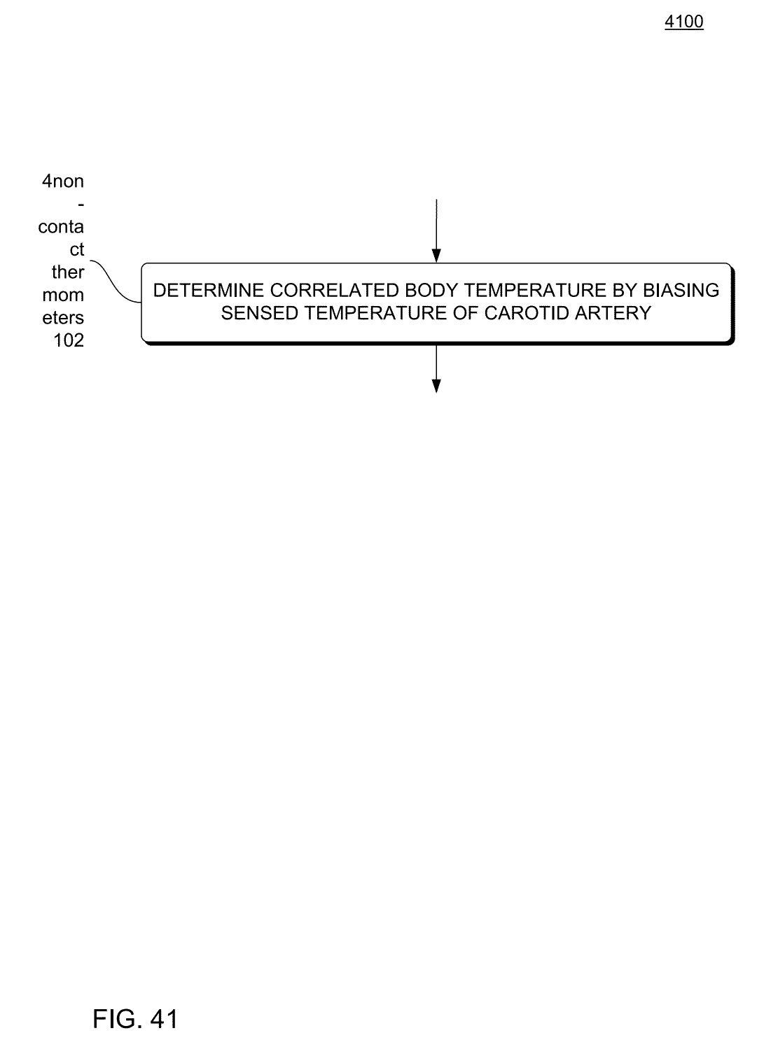

FIG. 41 is a flowchart of a method of determining correlated temperature of a carotid artery, according to an implementation;

Method 4100 includes determining a correlated body temperature of carotid artery by biasing a sensed temperature of a carotid artery, at block 4102. In one example, the sensed temperature is biased by +0.5° C. to yield the correlated body temperature. In another example, the sensed temperature is biased by −0.5° C. to yield the correlated body temperature. Method 4100 in FIG. 40 is one example of block 3904 in FIG. 39 and block 4004 in FIG. 40. An example of correlating body temperature of a carotid artery follows:
f_{ntc}(T_{ntc})=0.2° C. when T_{ntc}=26.2° C. as retrieved from a data table for body sensing mode.
assumption: T_{surface temp}=37.8° C.
T_{surface temp}+f_{ntc}(T_{ntc})=37.8° C.+0.2° C.=38.0° C.
f_{stb}(T_{surface temp}+f_{ntc}(T_{ntc}))=38° C.+1.4° C.=39.4° C.
assumption: F4_{body}=0.5° C.

$$\begin{matrix}{T}_{body} = \vert {f}_{stb} ( {T}_{surface temp} + {f}_{ntc} ( {T}_{ntc} ) ) + F {4}_{body} \vert \\ = \vert 39.4 ° C . + 0.5 C . \vert \\ = 39.9 ° C .\end{matrix}$$

The correlated temperature for the carotid artery is 39.9° C.

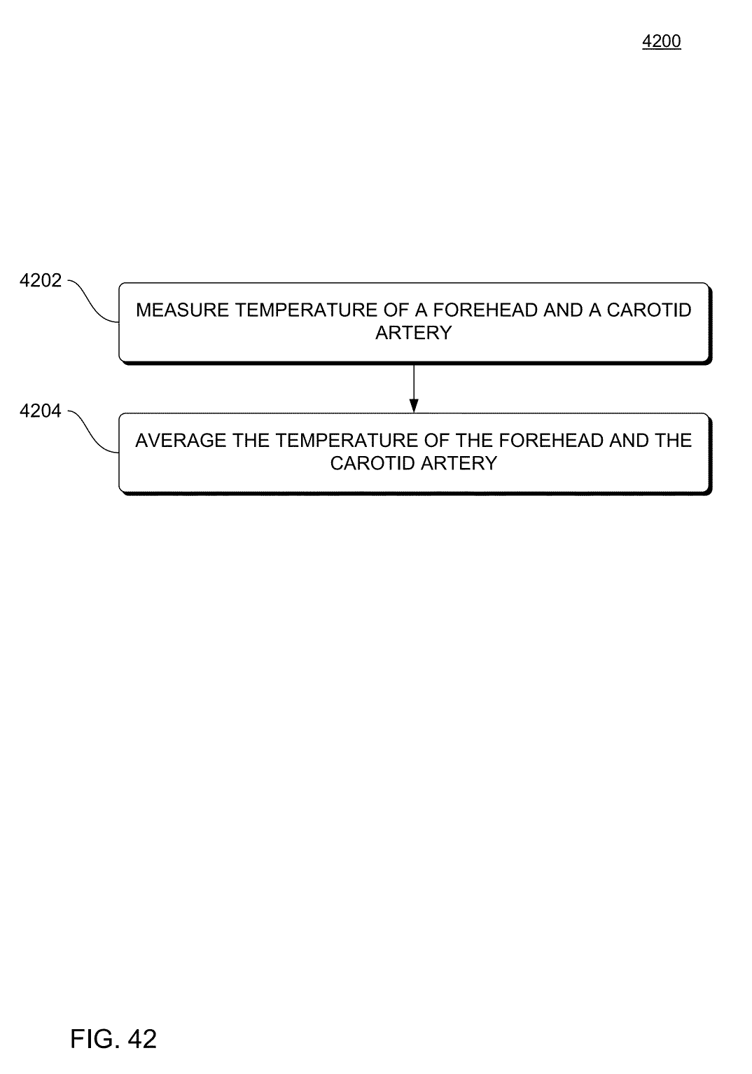

FIG. 42 is a flowchart of a method 4200 of forehead and carotid artery sensing, according to an implementation.

Method 4200 includes measuring temperature of a forehead and a carotid artery, at block 4202. Method 3900 in FIG. 39 is one example of block 4202. In an example of correlating temperature of a plurality of external locations, such as a forehead and a carotid artery to an axillary temperature, first a forehead temperature is calculated using formula 1 as follows:
f_{ntc}(T_{ntc})=0.2° C. when T_{ntc}=26.2° C. as retrieved from a data table for axillary sensing mode.
assumption: T_{surface temp}=37.8° C.
T_{surface temp}+f_{ntc}(T_{ntc})=37.8° C.+0.2° C.=38.0° C.
f_{stb}(T_{surface temp}+f_{ntc}(T_{ntc}))=38° C.+1.4° C.=39.4° C.
assumption: F4_{body}=0° C.
T_{body}=|f_{stb}(T_{surface temp}+f_{ntc}(T_{ntc}))+F4b_{ody}|=|39.4° C.+0 C|=39.4° C.

And second, a carotid temperature is calculated using formula 1 as follows:
f_{ntc}(T_{ntc})=0.6° C. when T_{ntc}=26.4° C. as retrieved from a data table.
assumption: T_{surface temp}=38.0° C.
T_{surface temp}+f_{ntc}(T_{ntc})=38.0° C.+0.6° C.=38.6° C.
f_{stb}(T_{surface temp}+f_{ntc}(T_{ntc}))=38.6° C.+1.4 C=40.0° C.
assumption: F4_{body}=0° C.
T_{body}=|f_{stb}(T_{surface temp}+f_{ntc}(T_{ntc}))+F4_{body}|=140.0° C.+0 C|=40.0° C.

Thereafter the correlated temperature for the forehead (39.4° C.) and the correlated temperature for the carotid artery (40.0° C.) are averaged, at block 4204, yielding the final result of the scan of the forehead and the carotid artery as 39.7° C.

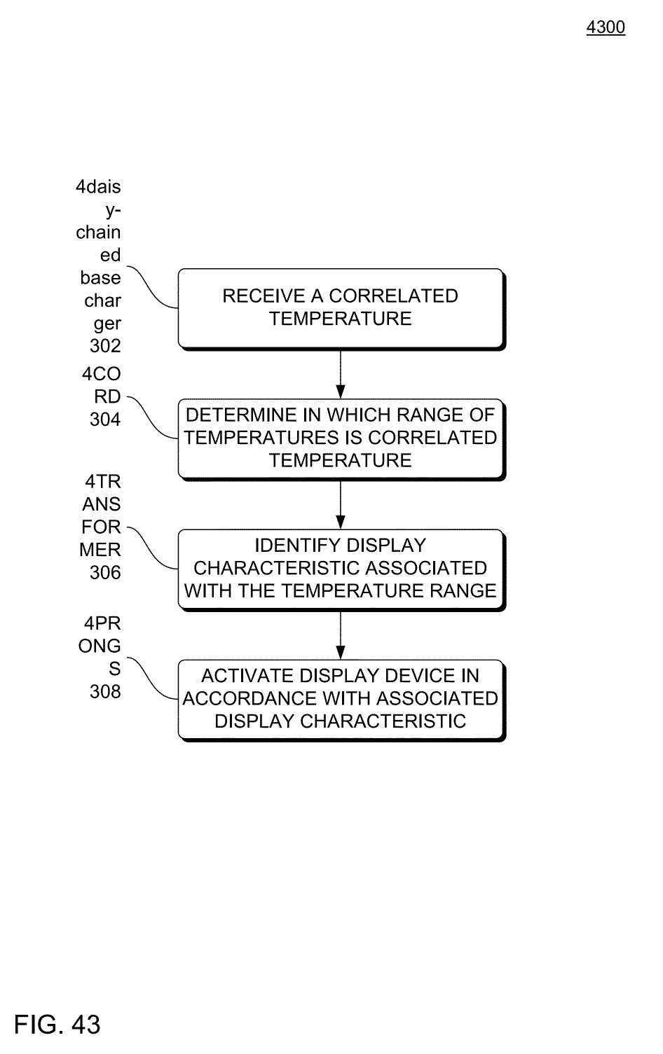

FIG. 43 is a flowchart of a method 4300 to display temperature color indicators, according to an implementation. Method 4300 provides color rendering in the display device 1004 to indicate a general range of a correlated temperature.

Method 4300 includes receiving a correlated temperature, at block 4302. The correlated temperature can be received from the non-contact sensor 1010 or the contact sensor 312, or the correlated temperature can be received from a printed circuit board that has adjusted a temperature in reference to either the site on the human or animal of the temperature sensing and or the ambient temperature detected in the vicinity of the apparatus performing the method 4300.

Method 4300 also includes determining in which of a plurality of ranges is the correlated temperature, at block 4304.

Method 4300 also includes identifying a display characteristic that is associated with the determined temperature range, at block 4306. In some implementations, the display characteristic is a color of text. In some implementations, the display characteristic is an image such as a commercial advertisement image.

Method 4300 also includes activating the display device 1004 in accordance with the identified display characteristic, at block 4308. In the implementations in which the display characteristic is a color of text, method 4300 provides color rendering in the display device 1004 to indicate the general range of the sensed temperature. The medical significance of the temperature is indicated by the displayed color. In the implementations in which the display characteristic is an image such as a commercial advertisement image, method 4300 provides advertising that is relevant to the medical condition of a patient.

In one implementation of a method to display temperature color indicators, according to an implementation of two colors, the method includes the non-contact sensor (such as 1010 in FIG. 10) yielding a sensed temperature that is correlated and color changes of the display device (such as 1004 in FIG. 10) are related to the correlated temperature, and the display device activates pixels in at least two colors, the colors being in accordance with the correlated temperature.

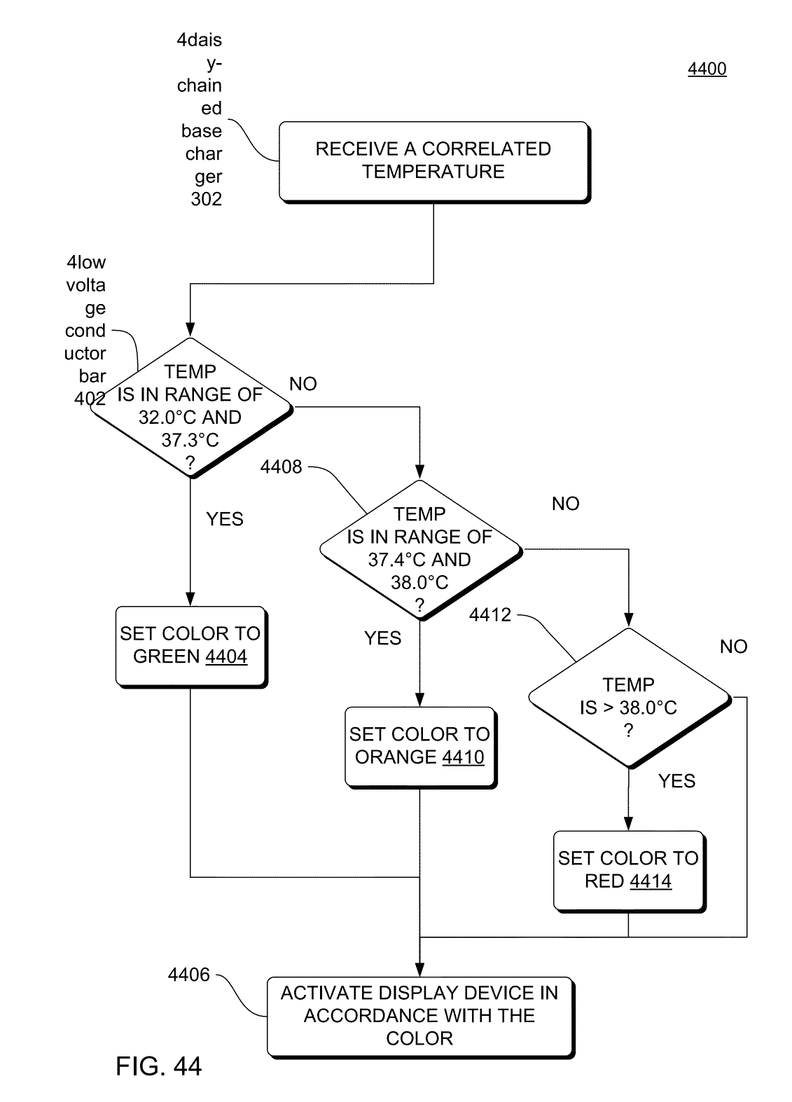

FIG. 44 is a flowchart of a method 4400 to display temperature color indicators, according to an implementation of three colors. Method 4400 provides color rendering in the display device 1004 to indicate a general range of a correlated temperature.

Method 4400 includes receiving a correlated temperature, at block 2502. The correlated temperature can be received from the non-contact sensor 1010 or the contact sensor 312, or the correlated temperature can be received from a printed circuit board that has adjusted a temperature in reference to either the site on the human or animal of the temperature sensing and or the ambient temperature detected in the vicinity of the apparatus performing the method 4400.

Method 4400 also includes determining whether or not the correlated temperature is in the range of 32.0° C. and 37.3° C., at block 4402. If the correlated temperature is in the range of 32.0° C. and 37.3° C., then the color is set to ‘green’ to indicate a temperature of no medical concern, at block 4404 and the background of the display device 1004 is activated in accordance with the color, at block 4406.

If the correlated temperature is not the range of 32.0° C. and 37.3° C., then method 4400 also includes determining whether or not the correlated temperature is in the range of 37.4° C. and 38.0° C., at block 4408. If the sensed temperature is in the range of 37.4° C. and 38.0° C., then the color is set to ‘orange’ to indicate caution, at block 4410 and the background of the display device 1004 is activated in accordance with the color, at block 4406.

If the correlated temperature is not the range of 37.4° C. and 38.0° C., then method 4400 also includes determining whether or not the correlated temperature is over 38.0° C., at block 4412. If the correlated temperature is over 38.0° C., then the color is set to ‘red’ to indicate alert, at block 4412 and the background of the display device 1004 is activated in accordance with the color, at block 4406.

Method 4400 assumes that temperature is correlated in gradients of 10ths of a degree. Other temperature range boundaries are used in accordance with other gradients of temperature sensing.

In some implementations, some pixels in the display device 1004 are activated as a green color when the correlated temperature is between 36.3° C. and 37.3° C. (97.3° F. to 99.1° F.), some pixels in the display device 1004 are activated as an orange color when the correlated temperature is between 37.4° C. and 37.9° C. (99.3° F. to 100.2° F.), some pixels in the display device 1004 are activated as a red color when the correlated temperature is greater than 38° C. (100.4° F.). In some implementations, the display device 1004 is a backlit LCD screen (which is easy to read in a dark room) and some pixels in the display device 1004 are activated (remain lit) for about 5 seconds after the button 1004 is released. After the display device 1004 has shut off, another temperature reading can be taken by the apparatus. The color change of the display device 1004 is to alert the user of the apparatus of a potential increase of body temperature of the human or animal subject. Temperature reported on the display can be used for treatment decisions.

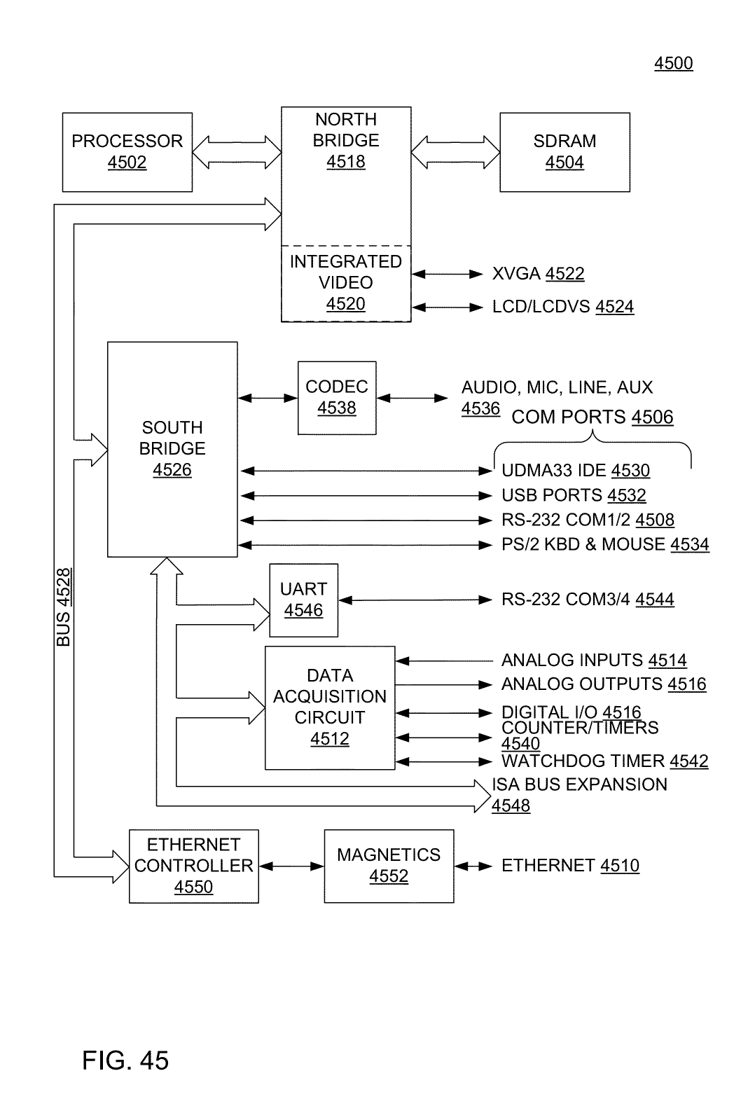

In some implementations, methods 3900-4400 are implemented as a sequence of instructions which, when executed by a processor 4502 in FIG. 45, cause the processor to perform the respective method. In other implementations, methods 3900-4400 are implemented as a computer-accessible medium having executable instructions capable of directing a processor, such as processor 4502 in FIG. 45, to perform the respective method. In varying implementations, the medium is a magnetic medium, an electronic medium, or an optical medium.

### Hardware and Operating Environment

FIG. 45 is a block diagram of a thermometer control computer 4500, according to an implementation. The thermometer control computer 4500 includes a processor (such as a Pentium III processor from Intel Corp. in this example) which includes dynamic and static ram and non-volatile program read-only-memory (not shown), operating memory 4504 (SDRAM in this example), communication ports 4506 (e.g., RS-232 4508 COM1/2 or Ethernet 4510), and a data acquisition circuit 4512 with analog inputs 4514 and analog outputs 4516.

In some implementations of the thermometer control computer 4500, the data acquisition circuit 4512 is also coupled to counter timer ports 4540 and watchdog timer ports 4542. In some implementations of the thermometer control computer 4500, an RS-232 port 4544 is coupled through a universal asynchronous receiver/transmitter (UART) 4546 to a bridge 4526.

In some implementations of the thermometer control computer 4500, the Ethernet port 4510 is coupled to the bus 4528 through an Ethernet controller 4550.

With proper digital amplifiers and analog signal conditioners, the thermometer control computer 4500 can be programmed to drive the display device 1502. The sensed temperatures can be received by thermal sensors 110 and 1212, the output of which, after passing through appropriate signal conditioners, can be read by the analog to digital converters that are part of the data acquisition circuit 4512. Thus the temperatures can be made adjusted for ambient temperature or the physical site of the human or animal that was examined for temperature on in as part of its decision-making software that acts to process and display sensed temperature.

FIG. 46 is a block diagram of a data acquisition circuit 4600 of a thermometer control computer, according to an implementation. The data acquisition circuit 4600 is one example of the data acquisition circuit 4512 in FIG. 45 above. Some implementations of the data acquisition circuit 4600 provide 16-bit A/D performance with input voltage capability up to +/−10V, and programmable input ranges.

The data acquisition circuit 4600 can include a bus 4602, such as a conventional PC/104 bus. The data acquisition circuit 4600 can be operably coupled to a controller chip 4604. Some implementations of the controller chip 4604 include an analog/digital first-in/first-out (FIFO) buffer 4606 that is operably coupled to controller logic 4608. In some implementations of the data acquisition circuit 4600, the FIFO 4606 receives signal data from and analog/digital converter (ADC) 4610, which exchanges signal data with a programmable gain amplifier 4612, which receives data from a multiplexer 4614, which receives signal data from analog inputs 4616.

In some implementations of the data acquisition circuit 4600, the controller logic 4608 sends signal data to the ADC 4610 and a digital/analog converter (DAC) 4618. The DAC 4618 sends signal data to analog outputs. The analog outputs, after proper amplification, can be used to modulate coolant valve actuator positions. In some implementations of the data acquisition circuit 4600, the controller logic 4608 receives signal data from an external trigger 4622.

In some implementations of the data acquisition circuit 4600, the controller chip 4604 includes a digital input/output (I/O) component 4638 that sends digital signal data to computer output ports.

In some implementations of the data acquisition circuit 4600, the controller logic 4608 sends signal data to the bus 4602 via a control line 4646 and an interrupt line 4648. In some implementations of the data acquisition circuit 4600, the controller logic 4608 exchanges signal data to the bus 4602 via a transceiver 4650.

Some implementations of the data acquisition circuit 4600 include 12-bit D/A channels, programmable digital I/O lines, and programmable counter/timers. Analog circuitry can be placed away from the high-speed digital logic to ensure low-noise performance for important applications. Some implementations of the data acquisition circuit 4600 are fully supported by operating systems that can include, but are not limited to, DOS™, Linux™ RTLinux™, QNX™, Windows 98/NT/2000/XP/CE™, Forth™, and VxWorks™ to simplify application development.

### CONCLUSION

A non-contact thermometer that senses temperature of a plurality of external locations is described. A technical effect of the non-contact thermometer is visual display of a temperature that is correlated from the plurality of external locations. Another technical effect of the non-contact thermometer is visual display of a temperature that is correlated from a carotid source point. Although specific implementations are illustrated and described herein, it will be appreciated by those of ordinary skill in the art that any arrangement which is calculated to achieve the same purpose may be substituted for the specific implementations shown. This application is intended to cover any adaptations or variations.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future non-contact temperature sensing devices, different temperature measuring sites on humans or animals and new display devices.

The terminology used in this application meant to include all temperature sensors, processors and user environments and alternate technologies which provide the same functionality as described herein.

1. A daisy-chainable base charger for a non-contact thermometer, the charger comprising:
a daisy-chain female port;
a daisy-chain male port;
at least two conductors that are operably coupled to the daisy-chain female port to the daisy-chain male port that is in the daisy-chainable base charger; and
a low voltage conductor bar that is operably coupled to the daisy-chain female port to the daisy-chain male port, the low voltage conductor bar including a housing, a printed circuit board electrically operably coupled to the daisy-chain female port and to the daisy-chain male port, the low voltage conductor bar including a charging jack that is electrically and mechanically coupled to the printed circuit board and mechanically placed within the housing of the low voltage conductor bar, the charging jack being extant to a hole in an exterior of the housing, the low voltage conductor bar including at least one low voltage conductor rail that are electrically and mechanically coupled to the charging jack, the low voltage conductor rail are extant through holes of a top cover of the low voltage conductor bar, the top cover being mechanically attached to the housing,
wherein the daisy-chain female port and the daisy-chain male port have complementary physical interfaces,
wherein the daisy-chain female port and the daisy-chain male port are on opposite sides of the daisy-chain base charger,
when the daisy-chain female port is mated with a daisy-chain male port that is not in the daisy-chainable base charger, then electric power is operable to flow through the daisy-chain male port that is not in the daisy-chainable base charger and to the daisy-chain female port, and the electric power is operable to flow from the daisy-chain female port to the daisy-chain male port that is in the daisy-chainable base charger, thus providing electric power to the daisy-chain base charger to recharge a battery in the non-contact thermometer,
the daisy-chain base charger does not include a power cord that is interconnectable to an extant power outlet which reduces space requirements of each daisy-chain base charger and a cost of the daisy-chain base charger.

2. The daisy-chainable base charger of claim 1, wherein the low voltage conductor bar is attached to the daisy-chainable base charger at the bottom of the daisy-chainable base charger.

3. The daisy-chainable base charger of claim 1, wherein the low voltage conductor bar is attached to the daisy-chainable base charger at the back of the daisy-chainable base charger.

4. A daisy-chainable base charger for a non-contact thermometer, the charger comprising:
a daisy-chain female port;
a daisy-chain male port;
at least two conductors that are operably coupled to the daisy-chain female port to the daisy-chain male port that is in the daisy-chainable base charger; and
wherein the daisy-chain female port and the daisy-chain male port have complementary physical interfaces,
wherein the daisy-chain female port and the daisy-chain male port are on opposite sides of the daisy-chain base charger,
when the daisy-chain female port is mated with a daisy-chain male port that is not in the daisy-chainable base charger, then electric power is operable to flow through the daisy-chain male port that is not in the daisy-chainable base charger and to the daisy-chain female port, and the electric power is operable to flow from the daisy-chain female port to the daisy-chain male port that is in the daisy-chainable base charger, thus providing electric power to the daisy-chain base charger to recharge a battery in the non-contact thermometer,
the daisy-chain base charger does not include a power cord that is interconnectable to an extant power outlet which reduces space requirements of each daisy-chain base charger and a cost of the daisy-chain base charger.

5. The daisy-chainable base charger of claim 4, further comprising:
a low voltage conductor bar that is operably coupled to the daisy-chain female port to the daisy-chain male port, the low voltage conductor bar including a housing, a printed circuit board electrically operably coupled to the daisy-chain female port and to the daisy-chain male port, the low voltage conductor bar including a charging jack that is electrically and mechanically coupled to the printed circuit board and mechanically placed within the housing of the low voltage conductor bar, the charging jack being extant to a hole in an exterior of the housing, the low voltage conductor bar including at least one low voltage conductor rail that are electrically and mechanically coupled to the charging jack, the low voltage conductor rail are extant through holes of a top cover of the low voltage conductor bar, the top cover being mechanically attached to the housing,

6. The daisy-chainable base charger of claim 5, wherein the low voltage conductor bar is attached to the daisy-chainable base charger at the bottom of the daisy-chainable base charger.

7. The daisy-chainable base charger of claim 5, wherein the low voltage conductor bar is attached to the daisy-chainable base charger at the back of the daisy-chainable base charger.

8. A daisy-chainable base charger for a non-contact thermometer, the charger comprising:
a daisy-chain female port;
a daisy-chain male port;
at least two conductors that are operably coupled to the daisy-chain female port to the daisy-chain male port that is in the daisy-chainable base charger; and
wherein the daisy-chain female port and the daisy-chain male port have complementary physical interfaces,
wherein the daisy-chain female port and the daisy-chain male port are on opposite sides of the daisy-chain base charger,
when the daisy-chain female port is mated with a daisy-chain male port that is external to the daisy-chainable base charger, then electric power is operable to flow through the daisy-chain male port that is not in the daisy-chainable base charger and to the daisy-chain female port, and the electric power is operable to flow from the daisy-chain female port to the daisy-chain male port that is in the daisy-chainable base charger, thus providing electric power to the daisy-chain base charger to recharge a battery in the non-contact thermometer.

9. The daisy-chainable base charger of claim 8, further comprising:
the daisy-chain base charger does not include a power cord that is interconnectable to an extant power outlet which reduces space requirements of each daisy-chain base charger and a cost of the daisy-chain base charger.

10. The daisy-chainable base charger of claim 8, further comprising:
a low voltage conductor bar that is operably coupled to the daisy-chain female port to the daisy-chain male port.

11. The daisy-chainable base charger of claim 10, wherein the low voltage conductor bar further comprises:
a housing.

12. The daisy-chainable base charger of claim 10, wherein the low voltage conductor bar further comprises:
a printed circuit board electrically operably coupled to the daisy-chain female port and to the daisy-chain male port

13. The daisy-chainable base charger of claim 10, wherein the low voltage conductor bar further comprises:
a charging jack that is electrically and mechanically coupled to the printed circuit board and mechanically placed within the housing of the low voltage conductor bar, the charging jack being extant to a hole in an exterior of the housing.

14. The daisy-chainable base charger of claim 10, wherein the low voltage conductor bar further comprises:
at least one low voltage conductor rail that are electrically and mechanically coupled to the charging jack.

15. The daisy-chainable base charger of claim 10, wherein the low voltage it conductor bar further comprises:
the low voltage conductor rail are extant through holes of a top cover of the low voltage conductor bar, the top cover being mechanically attached to the housing.

16. The daisy-chainable base charger of claim 10, wherein the low voltage conductor bar is attached to the daisy-chainable base charger at the bottom of the daisy-chainable base charger.

17. The daisy-chainable base charger of claim 10, wherein the low voltage conductor bar is attached to the daisy-chainable base charger at the back of the daisy-chainable base charger.
